(19) United States
(12) Patent Application Publication
(10) Pub. No.: US 2018/0106199 A1
(43) Pub. Date: Apr. 19, 2018

(54) COMPRESSION RATIO ADJUSTMENT APPARATUS FOR INTERNAL COMBUSTION ENGINE

(71) Applicant: HITACHI AUTOMOTIVE SYSTEMS, LTD., Hitachinaka-shi, Ibaraki (JP)

(72) Inventors: Makoto NAKAMURA, Zushi-shi, Kanagawa (JP); Masahiro SHOJI, Atsugi-shi, Kanagawa (JP)

(73) Assignee: HITACHI AUTOMOTIVE SYSTEMS, LTD., Hitachinaka-shi, Ibaraki (JP)

(21) Appl. No.: 15/565,235

(22) PCT Filed: Apr. 8, 2016
(86) PCT No.: PCT/JP2016/061480

§ 371 Date: Oct. 9, 2017

(30) Foreign Application Priority Data
Apr. 17, 2015 (JP) 2015-084876

(51) Int. Cl. F02D 15/02; F02B 75/04

(52) U.S. Cl. CPC F02D 15/02; F02D 41/064; F02B 75/045

(57) ABSTRACT

An object of the present invention is to provide a variable mechanism apparatus for an internal combustion engine capable of preventing a crown surface of a piston and intake and exhaust valves from interfering with each other or sufficiently acquiring an internal EGR effect during an exhaust stroke when a piston position at a compression top dead center is raised to achieve a high mechanical compression ratio. The variable mechanism apparatus is configured to set a piston position at an intake (exhaust) top dead center to a lower position than the piston position at the compression top dead center by a variable compression ratio mechanism. According thereto, the variable mechanism apparatus can prevent the crown surface of the piston and the intake and exhaust valves from interfering with each other or sufficiently acquiring the internal EGR effect during the exhaust stroke by setting the piston position at the exhaust top dead center to the low position when the piston position at the compression top dead center is raised to achieve the high mechanical compression ratio.

### TECHNICAL FIELD

The present invention relates to a compression ratio adjustment apparatus for a four-cycle internal combustion engine, and, in particular, to a compression ratio adjustment apparatus for an internal combustion engine that includes a variable compression ratio mechanism configured to change a compression ratio of the engine by changing a top dead center position of a piston.

### BACKGROUND ART

As a conventional compression ratio adjustment apparatus for an internal combustion engine, one proposed method is to improve various performances of an engine by a combination of control of a variable compression ratio mechanism that variably controls a geometric compression ratio, i.e., a mechanical compression ratio of the internal combustion engine, and control of a variable valve actuating mechanism that variably controls an opening/closing timing of an intake/exhaust valve determining an actual compression ratio. For example, a compression ratio adjustment apparats for an internal combustion engine discussed in Japanese Patent Application Public Disclosure No. 2002-276446 (PTL 1) includes the variable valve actuating mechanism for variably controlling the closing timing of the intake/exhaust valve and also includes the variable compression ratio mechanism that variably controls the compression ratio.

Then, PTL 1 is configured to improve an engine performance in various operation regions by controlling the variable valve actuating mechanism and the variable compression ratio mechanism in cooperation. For example, in an idling and partial load region, PTL 1 establishes such a characteristic that the intake valve is controlled to a small operation angle by the variable valve actuating mechanism and a lift central angle is advanced along therewith, so that the intake valve is closed at a considerably earlier timing than a bottom dead center. This characteristic can reduce a significant pump loss. In this case, if the mechanism compression ratio is at a normal level, the actual compression ratio is reduced and combustion is deteriorated, whereby the compression ratio is increased by the variable compression ratio mechanism in a low load region.

Further, in an acceleration region, an intake charging efficiency should be increased, so that the variable valve actuating mechanism is controlled in such a manner that the intake valve is closed at a timing closer to the bottom dead center. Therefore, the compression ratio is reduced by the variable compression ratio mechanism to prevent occurrence of knocking in advance.

In this manner, controlling the variable compression ratio mechanism and the variable valve actuating mechanism in cooperation by combining them allows the internal combustion engine to improve the various performances thereof.

### CITATION LIST

### Patent Literature

PTL 1: Japanese Patent Application Public Disclosure No. 2002-276446

### SUMMARY OF INVENTION

### Technical Problem

Then, FIG. 8 in PTL 1 illustrates a posture of the mechanism at a compression top dead center. A left portion in FIG. 8 illustrates a piston position at the compression top dead center in high mechanical compression ratio control (the piston position is slightly high), and a right portion in FIG. 8 illustrates a piston position at the compression top dead center in low mechanical compression ratio control (the piston position is slightly low). Then, focusing on positions at an exhaust top dead center, the piston positions at the exhaust top dead center coincide with the respective piston positions at the compression top dead center illustrated in FIG. 8 in both the high mechanism compression ratio control and the low mechanical compression ratio control.

This is because the variable compression ratio mechanism discussed in PTL 1 is a mechanism operating based on one cycle set to a crank angle of 360 degrees, and therefore the piston position at the exhaust top dead center and the piston position at the compression top dead center coincide with each other in principle. Further, for the same reason, a piston position at an intake bottom dead center and a piston position at an expansion bottom dead center also coincide with each other. Therefore, the mechanical compression ratio and the mechanical expansion ratio also match with each other in principle.

Then, an attempt to raise the piston position at the compression top dead center to increase the mechanical compression ratio or the mechanical expansion ratio to improve the engine performance naturally automatically leads to a rise of the piston position at the exhaust top dead center. Then, the intake and exhaust valves are normally opened around the exhaust top dead center at a terminal stage of an exhaust stroke or an initial stage of an intake stroke. In other words, the exhaust valve is closed after the piston passes through the exhaust top dead center, and the intake valve starts being opened before the piston reaches the exhaust top dead center.

Therefore, when the piston position at the compression top dead center is raised, the intake and exhaust valves are closed during a compression stroke, so that a crown surface of the piston and the intake and exhaust valves do not mechanically interfere with each other and therefore involve no problem. However, the piston position at the exhaust top dead center is located at the same position as the position when the piston position at the compression top dead center is raised in principle, which means that the piston is raised to a high position with the intake and exhaust valves opened, leading to a high possibility that the crown surface of the piston and the intake and exhaust valves interfere with each other at the terminal stage of the exhaust stroke or the initial stage of the intake stroke.

Especially, this interference between the crown surface of the piston and the intake and exhaust valves becomes likely to occur in a high rotation region where an abnormal motion such as a jump and a bounce of the intake and exhaust valves easily occurs or when opening/closing phases or lifts of the intake and exhaust valves are changed.

Further, besides this mechanical interference between the crown surface of the piston and the intake and exhaust valves, when the piston position at the exhaust top dead center is raised to the piston position at the compression top dead center, the piston is lifted to a high position from the terminal stage of the exhaust stroke to the initial stage of the intake stroke, so that a volume in a combustion chamber reduces and an amount of high-temperature combusted gas remaining in the cylinder reduces. Therefore, this raise leads to a failure to keep high temperatures in the combustion chamber and an air-fuel mixture in the next intake stroke and thus a failure to sufficiently acquire a so-called internal EGR effect, thereby resulting in a bad influence imposed on exhaust emission. Especially, in such an operation state that the temperature in the combustion chamber is low, this raise imposes the bad influence on the exhaust emission.

In either case, the conventional variable compression ratio mechanism is configured in such a manner that the piston position at the exhaust top dead center and the piston position at the compression top dead center coincide with each other in principle, which leads to such a drawback that the crown surface of the piston and the intake and exhaust valves easily interfere with each other or such a drawback that the internal EGR effect cannot be sufficiently acquired from the terminal stage of the exhaust stroke to the initial stage of the intake stroke when the piston position at the compression top dead center is raised to establish the high mechanical compression ratio.

An object of the present invention is to provide a compression ratio adjustment apparatus for an internal combustion engine capable of reliably preventing the crown surface of the piston and the intake and exhaust valves from interfering with each other or sufficiently acquiring the internal EGR effect from the terminal stage of the exhaust stroke to the initial stage of the intake stroke even when the piston position at the compression top dead center is raised.

### Solution to Problem

The present invention is characterized in that the piston position at the exhaust top dead center is set to a lower position than the piston position at the compression top dead center by the variable compression ratio mechanism.

### Advantageous Effects of Invention

According to the present invention, it is possible to bring about an effect of, for example, being able to prevent the crown surface of the piston and the intake and exhaust valves from interfering with each other or being able to sufficiently acquire the internal EGR effect by setting the piston position at the exhaust top dead center to the low position, even when the piston position at the compression top dead center is raised.

### BRIEF DESCRIPTION OF DRAWINGS

FIG. 1 schematically illustrates an entire compression ratio adjustment apparatus according to the present invention.

FIG. 2 is a side view of main portions that illustrates a part of the compression ratio adjustment apparatus according to the present invention in cross section.

FIGS. 3(A) and 3(B) are front views of a piston position change mechanism with a front cover removed therefrom, and, in particular, FIGS. 3(A) and 3(B) illustrate a maximum delay angle control state and a maximum advance angle state, respectively.

FIGS. 4(A) to 4(D) illustrate an operation of converting a phase of a control shaft by a variable compression ratio mechanism used in first to third embodiments, and, in particular, FIGS. 4(A) to 4(D) illustrate states when an eccentric rotational phase of the control shaft is controlled to a control phase α1 (for example, 137 degrees), a control phase α2 (for example, 180 degrees), a control phase α3 (for example, 222 degrees), and a control phase α4 (for example, 240 degrees), respectively, at a rotational angle of a crankshaft (X=360 degrees) at which a crank pin faces approximately right above the crankshaft around a compression top dead center.

FIG. 5 illustrates a characteristic indicating a change in a height position of a piston in relation to a rotational angle of the crankshaft according to the first embodiment.

FIGS. 6(A) to 6(H) illustrate an operation of the variable compression ratio mechanism according to the first embodiment. In particular, FIGS. 6(A) to 6(D) illustrate a piston position when a vane rotor is in a maximum delay angle state (the control phase α4), and illustrate a position at an intake (exhaust) top dead center, a position at an intake bottom dead center, a position at a compression top dead center, and a position at an expansion bottom dead center, respectively. Further, FIGS. 6(E) to 6(H) illustrate a piston position when the vane rotor is in a maximum advance angle state (the control phase α3), and illustrate states in which the position is a position at the intake (exhaust) top dead center, a position at the intake bottom dead center, a position at the compression top dead center, and a position at the expansion bottom dead center, respectively.

FIG. 7 illustrates a characteristic indicating the change in the height position of the piston in relation to the rotational angle of the crankshaft according to a second embodiment.

FIGS. 8(A) to 8(H) illustrate an operation of the variable compression ratio mechanism according to the second embodiment. In particular, FIGS. 8(A) to 8(D) illustrate a piston position when the vane rotor is in the maximum advance angle state (a control phase α2), and illustrate a position at the intake (exhaust) top dead center, a position at the intake bottom dead center, a position at the compression top dead center, and a position at the expansion bottom dead center, respectively. Further, FIGS. 8(E) to 8(H) illustrate a piston position when the vane rotor is in the maximum delay angle state (the control phase α3), and illustrate states in which the position is a position at the intake (exhaust) top dead center, a position at the intake bottom dead center, a position at the compression top dead center, and a position at the expansion bottom dead center, respectively.

FIG. 9 illustrates a characteristic indicating the change in the height position of the piston in relation to the rotational angle of the crankshaft according to a third embodiment.

FIGS. 10(A) to 10(D) illustrate an operation of the variable compression ratio mechanism according to the present embodiment, and illustrate a piston position when the vane rotor is in the maximum advance angle state (a control phase α1). In particular, FIGS. 10(A) to 10(D) illustrate a position at the intake (exhaust) top dead center, a position at the intake bottom dead center, a position at the compression top dead center, and a position at the expansion bottom dead center, respectively.

FIG. 11 schematically illustrates an entire link mechanism of a compression ratio variable mechanism according to a fourth embodiment.

### DESCRIPTION OF EMBODIMENTS

In the following description, embodiments of the present invention will be described in detail with reference to the drawings, but the present invention is not limited to the embodiments that will be described below and a range thereof also includes various modifications and applications within a technical concept of the present invention.

### First Embodiment

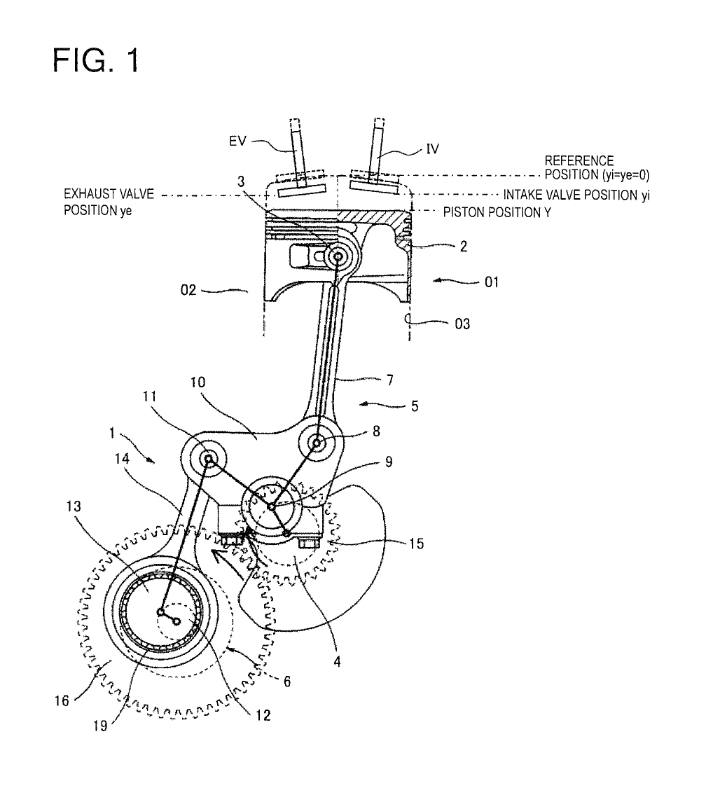

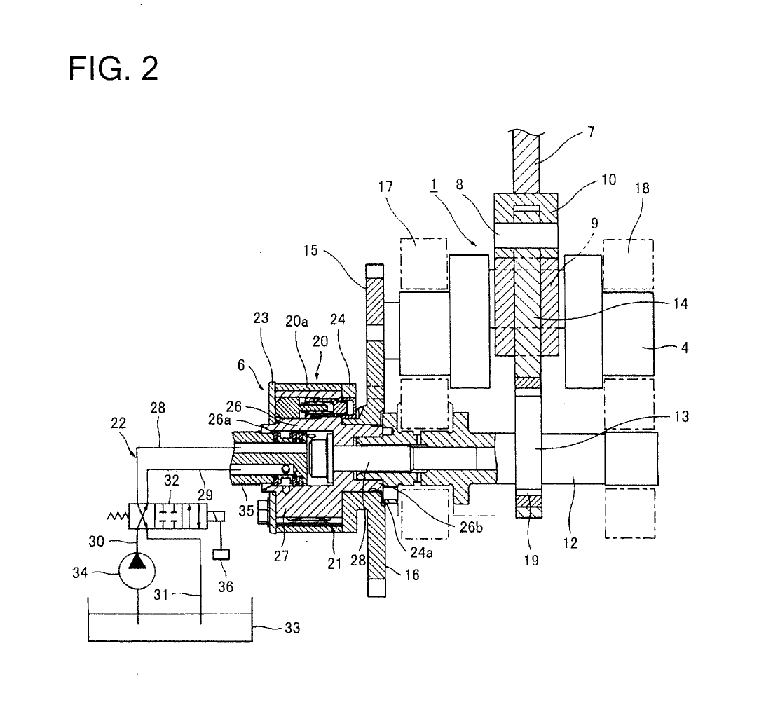

First, a first embodiment of the present invention will be described. FIGS. 1 and 2 schematically illustrate a configuration of a variable compression ratio mechanism. An internal combustion engine 01 includes a piston 2 and a crankshaft 4. The piston 2 reciprocates vertically along a cylinder bore 03 formed inside a cylinder block 02. The crankshaft 4 is rotationally driven by the vertical movement of the piston 2 via a piston pin 3 and a link mechanism 5 of a variable compression ratio mechanism 1, which will be described below. A space defined on a crown surface of the piston 2 illustrated in FIG. 1 between the piston 2 and a combustion chamber boundary line indicated by an alternate long and short dash line is a cylinder inner volume (a volume in a combustion chamber).

Further, an intake valve IV and an exhaust valve EV are provided in the combustion chamber, and are each opened and closed by a not-illustrated cam shaft. When being lifted toward a piston 2 side (a lower side), these intake valve IV and exhaust valve EV approach the crown surface of the piston as seen from FIG. 1. Now, a lift amount of the intake valve IV is expressed as a position yi from a reference position (yi=ye=0) in a direction in which the piston slidably moves, and a lift amount of the exhaust valve EV is expressed as a position ye from the reference position in the direction in which the piston slidably moved. Assume that Y represents a position of the piston 2 at this time. The reference position corresponds to a position at which both the intake valve IV and the exhaust valve EV are closed without being lifted. Then, an upward displacement of the piston position Y to the position yi of the intake valve IV or the position ye of the exhaust valve EV at some crank angle leads to occurrence of interference between the crown surface of the piston and the intake/exhaust valve.

The variable compression ratio mechanism 1 includes a link mechanism 5 including a plurality of links, a piston position change mechanism 6 that changes a posture of the link mechanism 5, and the like. The link mechanism 5 includes an upper link 7, a lower link 10, and a control link 14. The upper link 7 is a first link coupled with the piston 2 via the piston pin 3. The lower link 10 is a second link swingably coupled with the upper link 7 via a first coupling pin 8 and is also rotatably coupled with the crankshaft 4 via a crank pin 9. The control link 14 is a third link swingably coupled with the lower link 10 via a second coupling pin 11, and is also rotatably coupled with an eccentric cam portion 13 of a control shaft 12.

Further, a small-diameter first gear wheel 15, which is a driving rotational member, is fixed to a front end portion of the crankshaft 4 as illustrated in FIGS. 1 and 2 while a large-diameter second gear wheel 16, which is a driven rotational member, is provided on a front end portion side of the control shaft 12, and the variable compression ratio mechanism 1 is configured in such a manner that the first gear wheel 15 and the second gear wheel 16 are meshed with each other to allow a rotational force of the crankshaft 4 to be transmitted to the control shaft 12 via the piston position change mechanism 6.

The first gear wheel 15 has an outer diameter approximately half an outer diameter of the second gear wheel 16, and therefore a rotational speed of the crankshaft 4 is arranged so as to be transmitted to the control shaft 12 while being reduced to a half angler speed due to a difference between the outer diameters of the first gear wheel 15 and the second gear wheel 16. The control shaft 12 is configured in such a manner that a phase thereof with respect to the second gear wheel 16 is changed, i.e., a relative rotational phase with respect to the crankshaft 4 is changed by the piston position change mechanism 6.

The crankshaft 4 and the control shaft 12 are rotatably supported by common two bearings 17 and 18 provided on the cylinder block in front of and behind them. Further, the eccentric cam portion 13 is rotatably coupled with a large-diameter portion formed at a lower end portion of the control link 14 via a needle bearing 19.

The piston position change mechanism 6 is, for example, configured similarly to a hydraulic (vane-type) variable valve actuating mechanism discussed in Japanese Patent Application Public Disclosure No. 2012-225287 previously applied by the present applicant, which will be briefly described now.

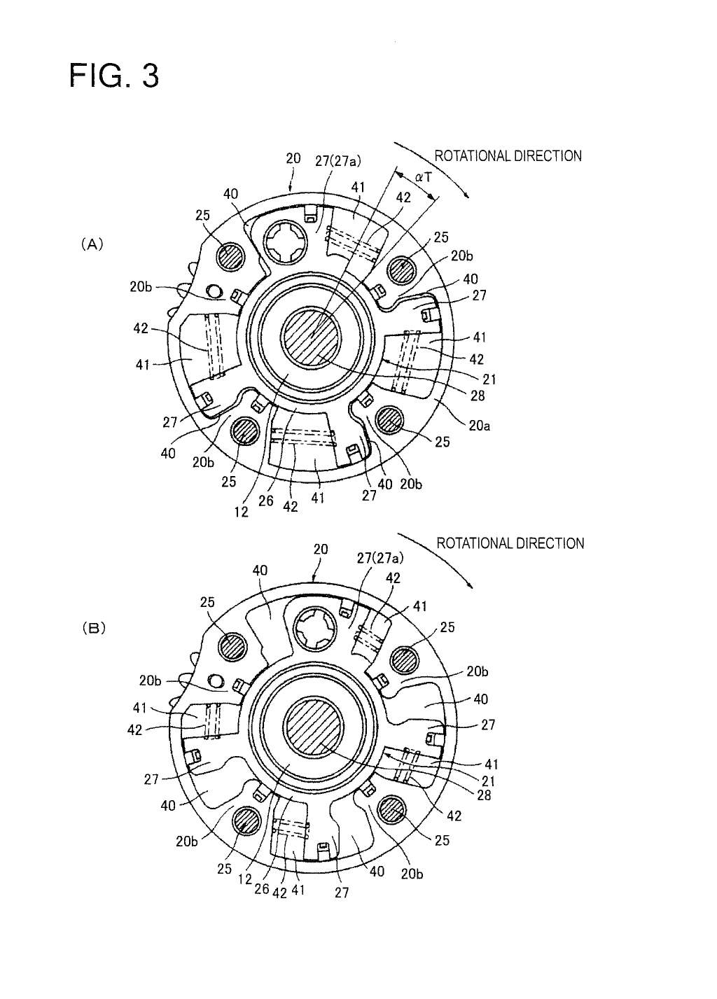

That is, as illustrated in FIGS. 2, and 3(A) and 3(B), this piston position change mechanism 6 includes a housing 20, a vane rotor 21, and a hydraulic circuit 22. The second gear wheel 16 is fixed in the housing 20. The vane rotor 21 is relatively ratably contained in the housing 20 and fixed to one end portion of the control shaft 12. The hydraulic circuit 22 hydraulically rotates the vane rotor 21 in a normal direction and an opposite direction.

The housing 20 includes a cylindrical housing main body 20a, which is closed at a front end opening thereof by a disk-shaped front cover 23 and is also closed at a rear end opening thereof by a disk-shaped rear cover 24. Further, shoes 20b, which are four partition walls, are formed so as to protrude inward at positions of approximately 90 degrees in a circumferential direction of an inner peripheral surface of the housing main body 20a.

The rear cover 24 is disposed at a central position of the second gear wheel 16 integrally with each other, and is fixed at an outer peripheral portion thereof to the housing main body 20a and the front cover 23 by being fastened together therewith with use of four bolts 25. Further, a large-diameter bearing hole 24a is formed so as to axially penetrate through an approximately central portion of the rear cover 24. An outer periphery of a cylindrical portion of the vane rotor 21 is borne by the bearing hole 24a.

The vane rotor 21 includes a cylindrical rotor 26 and four vanes 27. The rotor 26 includes a bolt insertion hole at a center thereof. The vanes 72 are integrally provided at positions of approximately 90 degrees in a circumferential direction of an outer peripheral surface of the rotor 26. The rotor 26 includes a small-diameter cylindrical portion 26a on a front end side thereof, and a small-diameter cylindrical portion 26b on a rear end side thereof. The small-diameter portion 26a is rotatably supported in a central support hole of the front cover 23, while the cylindrical portion 26b is rotatably supported in the bearing hole 24a of the rear cover 24.

Further, the vane rotor 21 is fixed to a front end portion of the control shaft 12 from an axial direction with use of a fixation bolt 28 inserted in the bolt insertion hole of the rotor 26 from the axial direction. Further, each of the vanes 27 is arranged between the individual shoes 20b, and a seal member and a plate spring are each fixedly attached and held in an elongated holding groove formed in an axial direction of an outer surface of each of the vanes 27. The seal member is in sliding contact with an inner peripheral surface of the housing main body 20a. The plate spring presses this seal member in a direction of the inner peripheral surface of the housing main body. Further, four advance angle chambers 40 and four delay angle a chambers 41 are individually defined between both sides of each of these vanes 27 and both side surfaces of each of the shoes 20b.

As illustrated in FIG. 2, the hydraulic circuit 22 includes two hydraulic passage systems, namely, a first hydraulic passage 28 and a second hydraulic passage 29. The first hydraulic passage 28 supplies and discharges a hydraulic pressure of hydraulic oil to and from each of the advance angle chambers 40. The second hydraulic passage 29 supplies and discharges the hydraulic pressure of the hydraulic oil to and from each of the delay angle chambers 41. A supply passage 30 and a drain passage 31 are each connected to both these hydraulic passages 28 and 29 via an electromagnetic switching valve 32 for switching the passage. A one-way oil pump 34, which pressure-feeds the oil in an oil pan 33, is provided in the supply passage 30, and a downstream end of the drain passage 31 is in communication with the oil pan 33.

The first and second hydraulic passages 28 and 29 are formed inside a passage forming portion provided on the front cover 23 side, and one end portion of each of them is in communication with inside the rotor 26 via a columnar portion 35 disposed by being inserted in an internal support hole from the small-diameter cylindrical portion 26a of the rotor 26 in the passage forming portion while an opposite end portion is connected to the electromagnetic switching valve 32.

The first hydraulic passage 28 includes not-illustrated four branch passages in communication with respective advance angle delay chambers 40, while the second hydraulic passage 29 includes a second oil passage in communication with each of the delay angle chambers 41. The electromagnetic switching valve 32 is a four-port three-position type valve, and an internal valve body thereof is configured to perform control of relatively switching each of the hydraulic passages 28 and 29, and the supply passage 30 and the drain passage 31, and is also configured to be switched to be activated according to a control signal from a control unit 36.

Then, the variable compression ratio mechanism 1 is configured to change the relative rotational phase of the vane rotor 21 (the control shaft 12) with respect to the crankshaft 4 by selectively supplying the hydraulic oil to each of the advance angle chambers 40 and each of the delay angle chambers 41 by the switched activation of the electromagnetic switching valve 32. Further, four coil springs 42 are each attached in each of the delay angle chambers 41. The coil spring 42 constantly biases the vane rotor 21 in a delay angle direction.

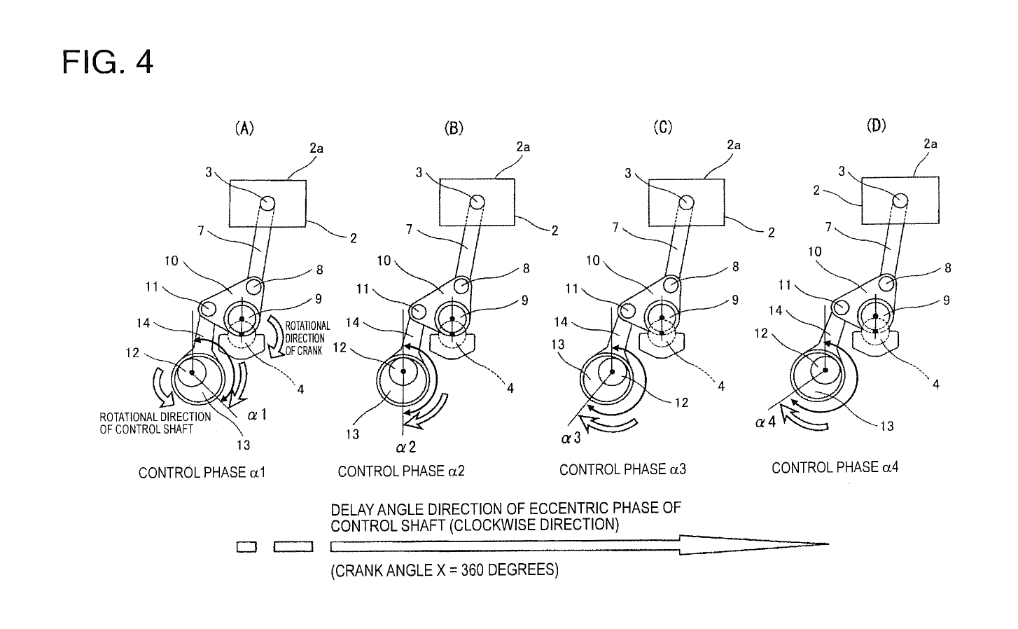

FIGS. 4(A) to 4(D) illustrate the second gear wheel 16 and the control shaft 12 when the relative rotational phase therebetween is changed. In these drawings, the first and second gear wheels 15 and 16 and the like are omitted. The present embodiment is configured to be able to change this relative rotational phase by control of converting the relative rotational phase that is performed by the above-described piston position change mechanism 6, but can also change the relative rotational phase by relatively changing an attachment relationship between the second gear wheel 16 and the control shaft 12 (the eccentric cam portion 13).

These drawings, FIGS. 4(A) to 4(D) each illustrate a posture when the crankshaft 4 is rotated in the clockwise direction without changing the relative phase between the second gear wheel 16 and the crank shaft 12 illustrated in FIG. 1, is further rotated once from a position where the crank pin 9 is oriented right above it (the crank angle X=0 degrees and around an intake (exhaust) top dead center), and is then located at a position where the crank pin 9 is oriented right above it again (X=360 degrees and around a compression top dead center). The intake (exhaust) top dead center refers to the exhaust top dead center (the intake top dead center), and refers to a position where the piston 2 is located at a highest position during a time period between a terminal stage of an exhaust stroke and an initial stage of an intake stroke.

At this time, the position (height) of the piston 2 is located around the compression top dead center and therefore located at a high position, and, for example, an eccentric direction of the eccentric cam portion 13 is located at a position delayed in the clockwise direction by a control phase α1 (for example, 137 degrees) from a direction right above the control shaft 12 as illustrated in FIG. 4A.

More specifically, the rotational direction of the eccentric cam portion 13 illustrated in FIGS. 4(A) to 4(D) is the counterclockwise direction opposite from the crankshaft, and therefore is delayed by α1 from the direction right above the control shaft 12 in the case of the state illustrated in FIG. 4(A). Such a case will be referred to as the control phase α1.

FIG. 4(B) illustrates a position when the phase of the control shaft (the eccentric cam portion 13) is further delayed as far as α2 (for example, 180 degrees) on the delay angle side from FIG. 4(A), i.e., the eccentric direction of the eccentric cam portion 13 is located around right below the control shaft 12, which will be referred to as a control phase α2.

Further, in cases illustrated in FIGS. 4(C) and 4(D), the control shaft 12 (the eccentric cam portion 13) is located at a position where the phase thereof is further delayed in the clockwise direction, as a control phase α3 (for example, 222 degrees) in FIG. 4(C) and the control phase α4 (for example, 240 degrees) in FIG. 4(D).

Then, for example, an operation of the phase change mechanism 6 (the piston position change mechanism) capable of achieving a conversion between the control phase α3 illustrated in FIG. 4(C) and the control phase α4 illustrated in FIG. 4(D) will be described with reference to FIGS. 3(A) and 3(B).

These drawings, FIGS. 3(A) and 3(B) illustrate the phase change mechanism 6 as viewed from a left side of FIG. 2, and the second gear wheel 16 is rotated in the clockwise direction in FIGS. 3(A) and 3(B). FIGS. 3(A) and 3(B) illustrate a maximum delay angle position (corresponding to the control phase α4) and a maximum advance angle position (corresponding to the control phase α3) of the vane rotor 21 of the piston position change mechanism 6, respectively, and the phase change mechanism 6 is configured in such a manner that both these maximum delay angle position and maximum advance angle position are regulated by stoppers (a delay angle-side stopper and an advance angle-side stopper) with both sides of the vane 27 (27a) having a largest widened width in abutment with one end surface and an opposite end surface of each of the shoes 20b adjacent thereto.

Then, the vane rotor 21 is configured to be mechanically stabilized around the maximum delay angle position by a spring force of each of the coil springs 42 as illustrated in FIG. 3(A). In other words, a default position is set to the maximum delay angle position.

Supposing that a phase conversion angle αT of the piston position change mechanism 6 is αT=α4−α3, such as 18 degrees (=240 degrees−222 degrees), a desired conversion angle αT (18 degrees) can be realized by the conversion between the control phase α3 and the control phase α4. Further, the desired phase conversion between FIGS. 4(C) and 4(D) (between the control phase α3 and the control phase α4) can be realized by setting the attachment position between the vane rotor 21 and the control shaft 12 in such a manner that the above-described maximum delay angle position (the default position) matches the control phase α4 illustrated in FIG. 4(D).

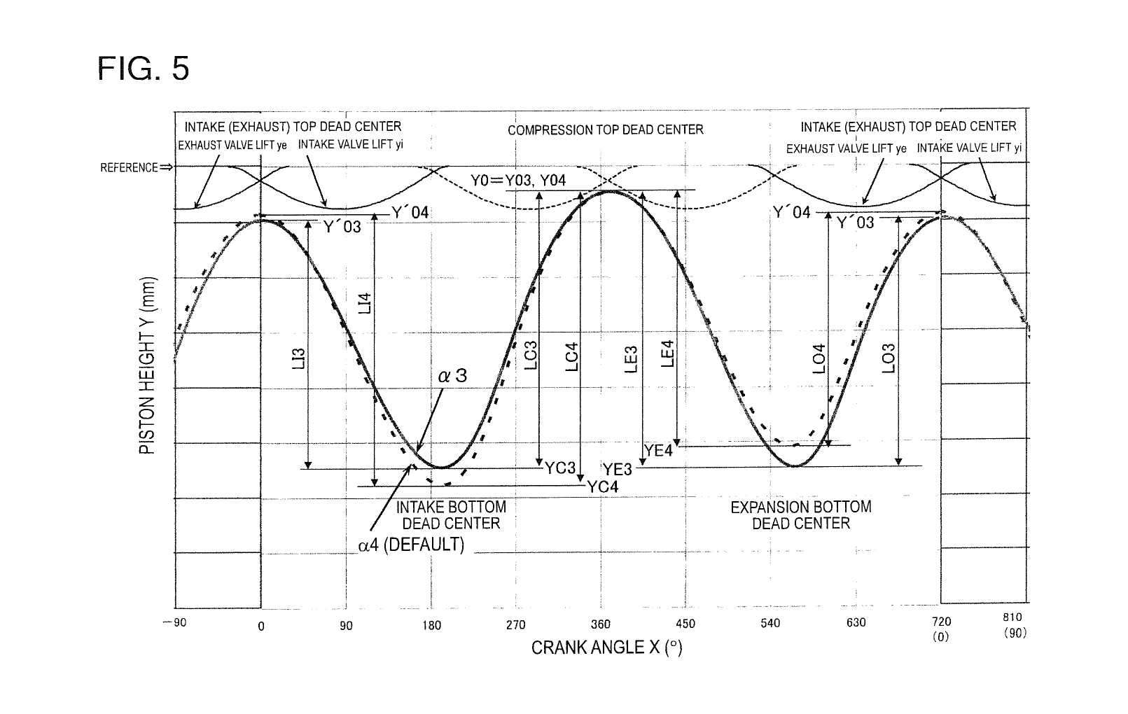

FIG. 5 illustrates a characteristic of a change in the piston position. In FIG. 5, the crank pin 9 is located right above the crankshaft 4 when the crank angle X is 0 degrees, and the piston 2 reaches the intake (exhaust) top dead center around there.

When the crank angle X starts rotating from 0 degrees in the clockwise direction, the exhaust valve EV is completely closed as indicated by an exhaust vale lift curve (ye). Further, an intake lift curve (yi) of the intake valve IV, which has started an opening operation before 0 degrees, is further increasingly lifted and introduces fresh air (or an air-fuel mixture) from an intake port. Next, the piston 2 reaches the intake bottom dead center around a position where the crank angle X reaches 180 degrees, and the intake valve is closed around there. Now, a cycle from the intake top dead center to the intake bottom dead center will be referred to as the intake stroke.

Further, when the crankshaft 4 is rotated, the intake valve IV is completely closed and the air-fuel mixture in the cylinder is compressed along therewith, and the piston 2 reaches the compression top dead center around a position where the crank angle X reaches 360 degrees (the crank pin 9 reaches the position right above the crankshaft 4 again). Now, a cycle from the intake bottom dead center to the compression top dead center will be referred to as a compression stroke.

After that, spark ignition (or compression ignition) is carried out and combustion is started, and the piston 2 is being pressed down by a combustion pressure thereof and reaches an expansion bottom dead center around a position where the crank angle X reaches 540 degrees. Now, a cycle from the compression top dead center to the expansion bottom dead center will be referred to as an expansion stroke.

An opening operation of the exhaust valve EV is started around this expansion bottom dead center, and combusted gas (exhaust gas) is emitted from the exhaust part together with a re-rise of the piston 2 and the crank angle X corresponding to around the intake (exhaust) top dead center returns to a position of 720 degrees (=0 degrees) (the crank pin 9 is located right above the crankshaft 4) again. Now, a cycle from the expansion bottom dead center to the intake (exhaust) top dead center will be referred to as the exhaust stroke.

In the above-described manner, the internal combustion engine 01 is activated as a four-cycle engine, and is periodically activated based on one cycle set to the crank angle (X) 720 degrees.

In FIG. 5, a solid line represents a piston position characteristic of the control phase α3 illustrated in FIG. 4(C) (an α3 characteristic), and a broken line represents a piston position characteristic of the control phase α4 illustrated in FIG. 4(D) (an α4 characteristic). The piston position at the compression top dead center is generally the same (Y0) in both the characteristics, and the intake bottom dead center position is different between both the characteristics. In other words, the cylinder inner volume (the volume in the combustion chamber) V at the compression top dead center is determined by the piston position at the compression top dead center (Y0) in both the characteristics, and therefore is set to a cylinder inner volume V0, which is approximately the same therebetween.

This cylinder inner volume V0 is a volume surrounded by a shape of an inner surface of the combustion chamber on the cylinder head side, a shape of the crown surface 2a of the piston 2, an inner diameter of the cylinder block 02, an inner diameter of a not-illustrated head gasket, and the like at the compression top dead center, i.e., a volume of gas (the air-fuel mixture) at the compression top dead center.

In the characteristic of the control phase α3 illustrated in FIG. 5, the piston position at the intake bottom dead center is YC3, and a length from this position to the compression top dead center (the compression stroke) is LC3. The piston position at the expansion bottom dead center is YE3, and a length from this position to the compression top dead center (the expansion stroke) is LE3.

Further, the piston position at the intake bottom dead center is the above-described position, YC3, and a length from this position to the intake (exhaust) top dead center (the intake stroke) is LI3. The piston position at the expansion bottom dead center is the above-described position, YE3, and a length from this position to the intake (exhaust) top dead center (the exhaust stroke) is L03.

Similarly, in the characteristic of the control phase α4 illustrated in FIG. 5, the piston position at the intake bottom dead center is YC4, and a length from this position to the compression top dead center (the compression stroke) is LC4. The piston position at the expansion bottom dead center is YE4, and a length from this position to the compression top dead center (the expansion stroke) is LE4.

Further, the piston position at the intake bottom dead center is the above-described position, YC4, and a length from this position to the intake (exhaust) top dead center (the intake stroke) is LI4. The piston position at the expansion bottom dead center is the above-described position, YE4, and a length from this position to the intake (exhaust) top dead center (the exhaust stoke) is LO4.

The intake (exhaust) top dead center and the exhaust (intake) top dead center refer to the same point, and refer to a top dead center of the piston when the piston shifts from the exhaust stoke to the intake stroke. Therefore, the intake (exhaust) top dead center and the exhaust (intake) top dead center may also be referred to as simply the intake top dead center or the exhaust top dead center.

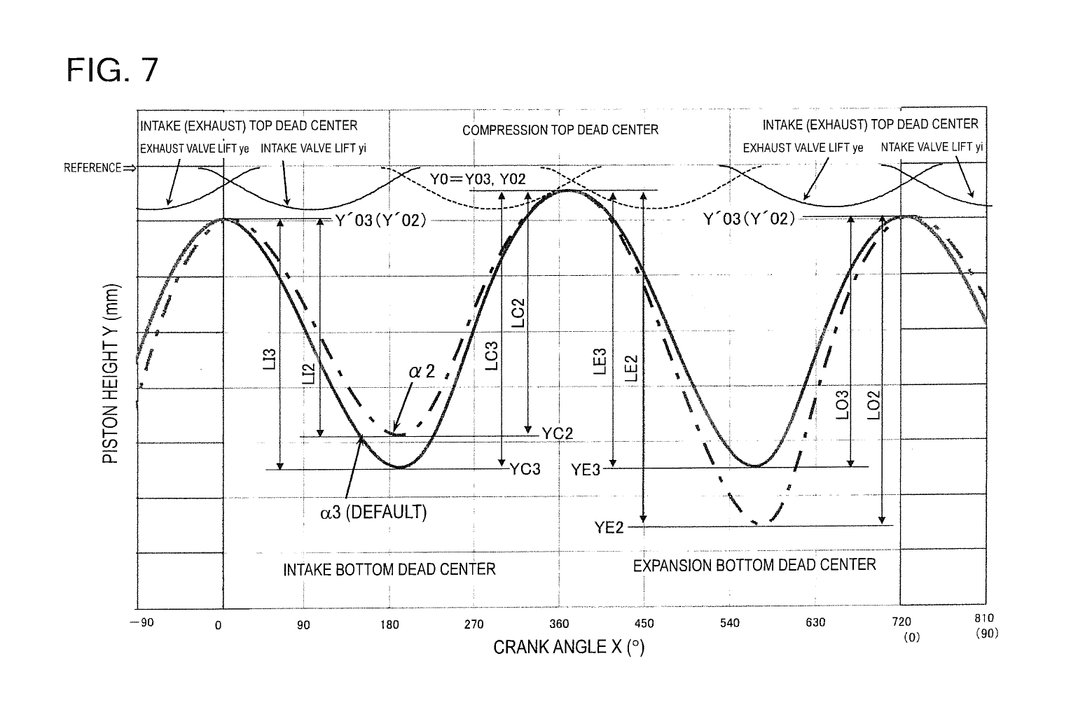

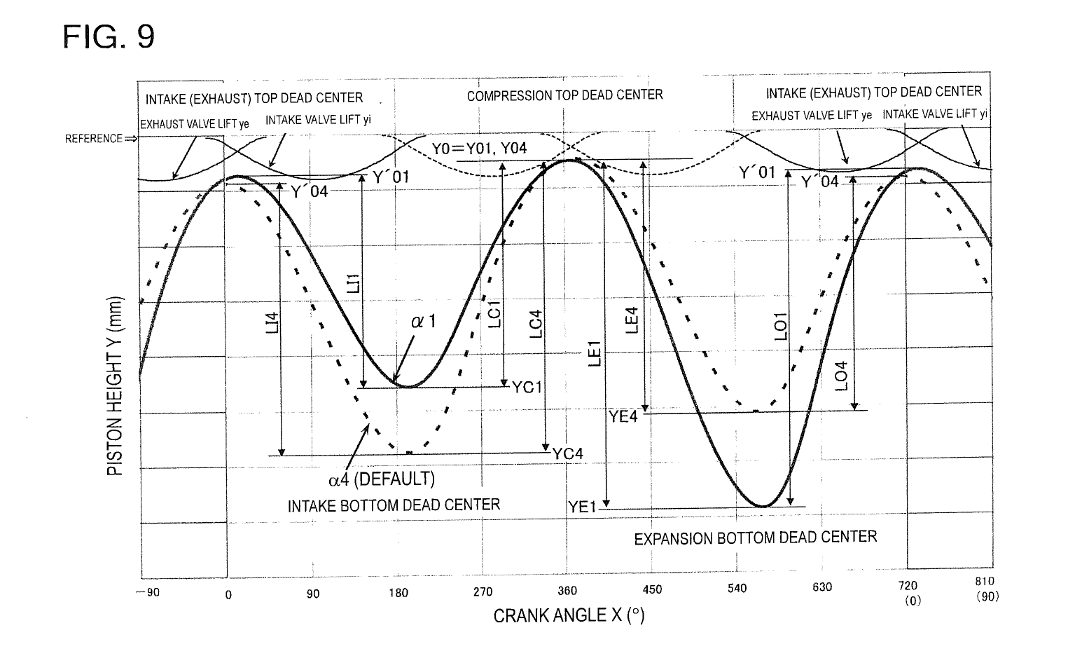

The above-described description regarding FIG. 5 also applies to FIG. 7 according to a second embodiment and FIG. 9 according to a third embodiment, and therefore detailed descriptions of FIGS. 7 and 9 will be omitted below.

Now, a mechanical compression ratio C3, which is a mechanical compression ratio in the control phase α3, and a mechanical expansion ratio E3, which is a mechanical expansion ratio in the control phase α3, will be analyzed. Assuming that S represents an area of the bore (a cylinder inner diameter), a cylinder inner volume VC3 at the intake bottom dead center is VC3=V0+S×LC3. Therefore, the mechanical compression ratio C3 is C3=VC3÷V0=(V0+S×LC3)÷V0.

On the other hand, the mechanical expansion ratio E3 is E3=VE3÷V0=(V0+S×LE3)÷V0. In this equation, VE3 represents a cylinder inner volume at the expansion bottom dead center.

In the case of the control phase α3, since the dimensional relationship is LC3≈LE3 as illustrated in FIG. 5, the relationship between the mechanical ratios is the mechanical compression ratio C3≈the mechanical expansion ratio LE3. Now, a relative ratio D is defined to be the relative ratio D=the mechanical expansion ratio E÷the mechanical compression ratio C.

A relative ratio D3 in the control phase α3 is E3÷C3≈1, which means such a generally standard characteristic that the mechanical expansion ratio E and the mechanical compression ratio C are approximately equal to each other. In other words, in the control phase α3, the characteristic approaches a normal characteristic of the change in the piston position (E=C, D=1) of a commonly-used engine.

Next, a mechanical compression ratio C4, which is a mechanical compression ratio in the control phase α4, and a mechanical expansion ratio E4, which is a mechanical expansion ratio in the control phase α4, will be described.

Similarly to the control phase α3, the mechanical compression ratio C4 is C4=VC4÷V0=(V0+S×LC4)÷V0, and the mechanical expansion ratio E4 is E4=VE4÷V0=(V0+S×LE4)÷V0. Then, in the case of the control phase α4, the dimensional relationship is LC4>LE4 as illustrated in FIG. 5, and therefore the relationship between the mechanical ratios is the mechanical compression ratio C4>the mechanical expansion ratio E4. In other words, a relative ratio D4 is D4=LE4÷LC4<1, which means that the mechanical compression ratio is relatively larger than the mechanical expansion ratio. Further, comparing the characteristic of the control phase α4 with the characteristic of the control phase α3, the mechanical compression ratio of the control phase α4 is higher like C4>C3, and the mechanical expansion ratio of the control phase α4 is lower like E4<E3.

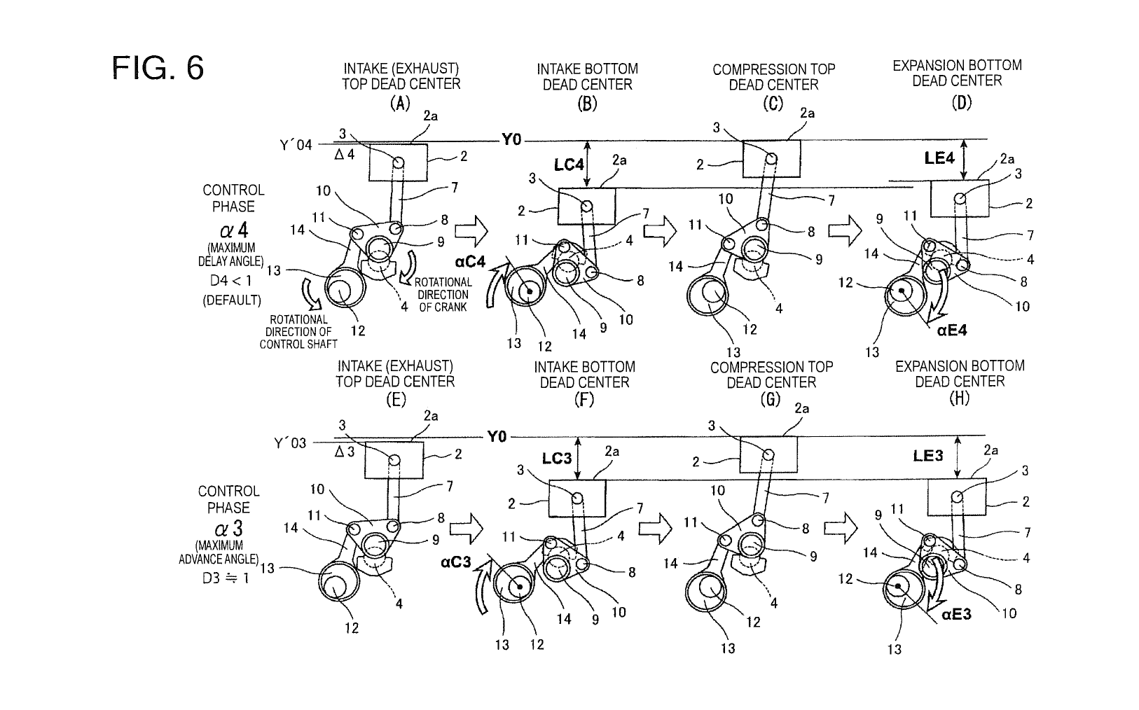

FIGS. 6(A) to 6(D) illustrate a change in the posture of the mechanism when the crank angle is changed in the control phase α4 (a default position of the maximum delay angle of the vane rotor 21 is, for example, 240 degrees), and FIGS. 6(E) to 6(H) illustrate a change in the posture of the mechanism when the crank angle is changed in the control phase α3 (a default position of the maximum advance angle of the vane rotor 21 is, for example, 222 degrees). In particular, FIGS. 6(A) and 6(E) each illustrate a posture at the intake (exhaust) top dead center. FIGS. 6(B) and 6(F) each illustrate a posture at the intake bottom dead center. FIGS. 6(C) and 6(G) each illustrate a posture at the compression top dead center. FIGS. 6(D) and 6(G) each illustrate a posture at the expansion bottom dead center.

In the case of the control phase α4 illustrated in FIGS. 6(A) to 6(D), the dimensional relationship is LC4>LE as described above, and therefore the relationship between the mechanical ratios is the mechanical compression ratio C4>the mechanical expansion ratio E4 (the relative ratio D4<1). On the other hand, in the case of the control phase α3 illustrated in FIGS. 6(E) to 6(H), the dimensional relationship is LC3≈LE3 as described above, and therefore the relationship between the mechanical ratios is the mechanical compression ratio C3≈the mechanical expansion ratio E3 (the relative ratio D3≈1). Then, in the case of the control phase α4 illustrated in FIGS. 6(A) to 6(D), comparing the control phase α3 with the control phase α3 illustrated in FIGS. 6(E) to 6(H), the dimensional relationships are LC4>LC3 and LE4<LE3 as described above.

A reason why such a characteristic of the change in the piston position is established will be described now. Focusing on an eccentric rotational direction αC of the eccentric cam portion 13 at the intake bottom dead center, αC4 in the control phase α4 illustrated in FIG. 6(B) is out of phase with αC3 in the control phase α3 illustrated in FIG. 6(F) in the clockwise direction (the delay angle direction). In other words, a center of an eccentric circle of the eccentric cam portion 13 is displaced to the upper right relative to the control phase α3, which causes the control link 14 to press up the second coupling pin 11 to the upper right, thereby rotating the lower link 10 in the clockwise direction with use of the crank pin 9 as a supporting point. As a result, the position of the first coupling pin 8 is lowered, and thus the piston 2 is pulled down by the upper link 7. In this manner, the lengths have the relationship LC4>LC3

On the other hand, focusing on an eccentric rotational direction αE of the eccentric cam portion 13 at the expansion bottom dead center, αE4 in the control phase α4 illustrated in FIG. 6(D) is also out of phase with αE3 in the control phase α3 illustrated in FIG. 6(H) in the clockwise direction (the delay angle direction). In other words, the center of the eccentric circle is relatively displaced downward, which causes the control link 14 to pull down the second coupling pin 11 to the lower left, thereby rotating the lower link 10 in the counterclockwise direction with use of the crank pin 9 as a supporting point. As a result, the position of the first coupling pin 8 is raised, and thus the piston 2 is pushed up by the upper link 7. In this manner, the lengths have the relationship LE4<LE3.

In other words, a difference in the characteristic of the change in the piston position between the control phase α3 and the control phase α4 illustrated in FIG. 5 is generated due to a difference in the link posture based on a difference in the eccentricity phase of the eccentric cam portion 13 illustrated in FIGS. 6(A) to 6(H).

On the other hand, focusing on the piston position at the compression top dead center, the position of the piston 2 is approximately the same between the control phase α3 and the control phase α4 as described above, and a reason therefor is as follows. That is, the crank pin 9, the first coupling pin 8, and the piston pin 3 are arranged in a generally straight line in both the control phase α3 and the control phase α4 as indicated by the postures at the compression top dead center illustrated in FIGS. 6(C) and 6(G), and this arrangement slightly reduces the change in the position of the piston pin 2 even when the first coupling pin 8 is pivotally moved by the pivotal movement of the lower link 10.

Therefore, the piston position at the compression top dead center in the control phase α3 (Y03 in FIG. 5) and the piston position at the compression top dead center in the control phase α4 (Y04 in FIG. 5) are located at approximately same positions, and this position is defined to be the above-described piston position at the compression top dead center (Y0).

However, in a case where a significant difference is generated between the piston position at the compression top dead center (Y03) and the piston position at the compression top dead center (Y04), this case can be dealt with by acquiring the respective relative ratios D3 and D4 between the respective mechanical compression ratios C3 and C4 and the respective mechanical expansion ratios E3 and E4 with use of V03 and V04 as the cylinder inner volumes instead of the above-described volume V0, respectively.

Next, effects relating to an engine performance according to the present embodiment will be described.

When the engine is out of operation, the vane rotor 21 of the piston position change mechanism 6 is stabilized at the maximum delay angle position (in the counterclockwise direction) illustrated in FIG. 3(A) (the default position) by being pressed by the spring force of each of the coil springs 42, and the control phase at this time is the above-described control phase α4.

Therefore, the variable compression ratio mechanism 1 is preset to the characteristic of the control phase α4 (the broken line in FIG. 5), which is the maximum delay angle position of the vane rotor 21, and can acquire an effect of reducing exhaust emission due to this characteristic from the very beginning of start ignition by the default setting. Further, even when a failure such as a disconnection has occurred in an electric system of the electromagnetic switching valve 32 of the piston position change mechanism 6, this position can be maintained, so that the variable compression ratio mechanism 1 can acquire the above-described effect of reducing the exhaust emission even in this case, thereby also achieving a so-called mechanical failsafe effect.

In other words, a first reason why the effect of reducing the exhaust emission can be acquired at the time of the cold start due to this characteristic is that the reduction in the mechanical expansion ratio E4 leads to an increase in a temperature of exhaust gas emitted from the internal combustion engine by an amount corresponding to a reduction in expansion work, thereby facilitating warm-up of a downstream catalyst and thus improving an emission conversion ratio.

On the other hand, a second reason is that the increase in the mechanical compression ratio C4 leads to an increase in the gas temperature in the cylinder at the compression top dead center, thereby improving a combustion failure, which becomes a problem at the time of a cold operation, and thus reducing the emission emitted from the internal combustion engine itself.

Reducing the above-described mechanical expansion ratio E4 while increasing the mechanical compression ratio C4, i.e., reducing the relative ratio D4 (=E4÷C4) allows the variable compression ratio mechanism 1 to considerably reduce an amount of the exhaust emission emitted from a tailpipe downstream of the catalyst into the air as a synergistic effect of the above-described individual effects.

Then, the relative ratio D4 is a value as small as less than 1, and a smaller value as this relative ratio D4 means a relatively lower mechanical expansion ratio and thus a relatively higher mechanical compression ratio, so that the relative ratio D4 can be regarded as an index indicating excellence of the exhaust emission performance at the time of the cold operation.

Then, when the warm-up of the engine is completed, fuel efficiency reduces if the mechanical compression ratio C4, the mechanical expansion ratio E4, and the relative ratio D4 are maintained when, for example, an engine operation state is a partial load. This is because the expansion work by the piston 2 reduces due to the low mechanical expansion ratio E4, and, further, a temperature at the compression top dead center excessively increases after the warm-up due to the high mechanical compression ratio C4, so that a so-called cooling loss increases, thus resulting in the reduction in the fuel efficiency due to these losses.

Further, when the engine operation state is a high load, abnormal combustion such as knocking and pre-ignition is also undesirably induced, and causes a further reduction in the fuel efficiency and also causes a torque reduction. Therefore, a preferable operation is to, after the warm-up, convert the vane rotor 21 to the maximum advance angle position with use of the control hydraulic pressure from the electromagnetic valve 32 of the piston position change mechanism 6, thereby switching the control phase to the control phase α3 (the characteristic indicated by the solid line in FIG. 5).

As a result, the characteristic matches the normal characteristic in the change of the piston position as the standard mechanical expansion ratio E3 and the standard mechanical compression ratio C3 are regained, and the relative ratio D3 returns to approximately 1, which allows the variable compression ratio mechanism 1 to prevent or cut down the reduction in the fuel efficiency due to the above-described losses and further the induction of the abnormal combustion.

When the engine has a temperature between the cold operation and the completion of the warm-up, the exhaust emission performance and the fuel efficiency performance can be approximately balanced for each change in the temperature by changing the vane rotor 21 toward the delay angle side (shifting toward the control phase α4) as the temperature reduces, and changing the vane rotor 21 toward the advance angle side (shifting toward the control phase α3) as the temperature increases according to the temperature of the engine. For example, the reduction in the fuel efficiency can be prevented or cut down as much as possible while the emission can be reduced to a sufficiently low predetermined value.

Then, the characteristic of the change in the position of the piston 2 is such a characteristic that a periodic operation is performed based on one cycle set to the crank angle 720 degrees as described above, and two top dead centers occur at the positions where the crank angle is around 0 degrees and 360 degrees. Then, the top dead center around the crank angle 360 degrees (the above-described piston position, Y0) corresponds to the above-described top dead center where both the intake valve IV and the exhaust valve EV are completely closed, and each of the top dead centers around the crank angle 0 degrees (Y′03 and Y′04) corresponds to the intake (exhaust) top dead center where the exhaust valve EV is closed and the intake valve IV starts operating around there.

Each of the piston positions at this intake (exhaust) top dead center (Y′03 and Y′04) is located at a lower position than the piston position at the compression top dead center (Y0). This is because the crank pin 9, the first coupling pin 8, and the piston pin 3 are not arranged in one straight line but are arranged in a left dogleg-like bent shape and this arrangement causes the piston position to be located at the lower position than the above-described piston position (Y0) in both the control phase α3 and the control phase α4 as indicated by the postures at the intake (exhaust) top dead center illustrated in FIGS. 6(A) and 6(E), and, further, the phase difference of the control shaft 12 between the control phase α3 and the control phase α4 leads to a significant difference in the piston position at the intake (exhaust) top dead center between the piston position in the former case (Y′03, and lowered by A3) and the piston position in the latter case (Y′04, and lowered by Δ4).

Then, the piston position at the intake (exhaust) top dead center (Y′03) is located at the lower position in the control phase α3 like the difference in the piston position Δ3>Δ4, because the eccentric direction of the eccentric cam portion 13 and the direction of the control link 14 (the third link) more resemble one straight line (an opening angle is closer to 180 degrees) in the control phase α3 as indicated by the piston positions at the intake (exhaust) top dead center illustrated in FIGS. 6(A) and 6(E), so that the lower link 10 is further pivotally moved in the clockwise direction and thus the piston pin (the piston) is pulled up via the upper link 7.

In this manner, each of the piston positions at the intake (exhaust) top dead center (Y′03 and Y′04) are located at the lower position than the piston position at the compression top dead center, which is extremely advantageous in terms of the interference between the piston 2, and the intake vale IV and the exhaust valve EV. At the intake (exhaust) top dead center illustrated in FIG. 5, each of the piston positions (Y′03 and Y′04) are lowered, and the position of the crown surface of the piston 2 (Y) is sufficiently downwardly separated from the intake valve lift position (yi) of the intake valve IV and the exhaust valve lift position (ye) of the exhaust valve Ev in terms of the crank angle around this intake (exhaust) top dead center, which makes the occurrence of the interference difficult.

For example, at the time of a high rotation, the intake valve IV and the exhaust valve EV are prone to occurrence of an abnormal motion such as a jump and a bounce, and yi and ye are slightly lowered in this case, but the interference with the intake valve IV and the exhaust valve EV can be sufficiently prevented. Further, in a case where the internal combustion engine is provided with the variable valve actuating mechanism capable of controlling the opening/closing phase of the intake valve IV and the exhaust valve EV and changing the lift amount itself so as to increase it, which has been being widely used in recent years, the mechanical interference between the intake valve IV and the exhaust valve EV, and the piston easily occurs. More specifically, in the control of the opening/closing phase, the yi characteristic and the ye characteristic shift in a direction along a horizontal axis (the crank angle), so that a distance to Y partially reduces. In the control of increasing the lift amount itself, the yi characteristic and the ye characteristic themselves shift downward, so that the distance to Y reduces. Even in such a case, the employment of the variable compression ratio mechanism according to the present embodiment allows the intake valve IV and the exhaust valve EV, and the piston to effectively prevent the mechanical interference therebetween.

Then, hypothetically supposing that the settings of the operation timings of the intake valve IV and the exhaust valve EV shift by approximately 360 degrees as the crank angle, there is raised such a problem that the high piston position (Y0) is located at the piston position at the intake (exhaust) top dead center and an interference allowance between the piston and the intake valve lift curve (yi) and the exhaust valve lift curve (ye) indicated by broken lines in FIG. 5 reduces, whereby the intake valve IV and the exhaust valve EV undesirably interfere with the piston at the time of the abnormal motion thereof such as the jump and the bounce. As seen from FIG. 5, the crank angle where the interference easily occurs is not the intake (exhaust) top dead center itself, but is generated when the distance between ye of the exhaust valve EV and the position Y of the crown surface of the piston just before the piston reaches the intake (exhaust) top dead center extremely reduces, and the distance between yi of the intake valve IV and the position Y of the crown surface of the piston just before the piston reaches the intake (exhaust) top dead center extremely reduces. When the abnormal motion of the intake/exhaust valve occurs under this circumstance, the distance therebetween further reduces, and thus the interference undesirably occurs.

Further, besides that, each of the piston positions at the intake (exhaust) top dead center (Y′03 and Y′04) is located at the lower position than the piston position at the compression top dead center (Y0), which brings about an effect of increasing the amount of remaining exhaust gas. In the case where the piston position at the intake (exhaust) top dead center is raised to the piston position at the compression top dead center like the conventional technique, the piston is raised to a high position and the volume in the combustion chamber reduces from the terminal stage of the exhaust stroke to the initial stage of the intake stroke, so that the amount of high-temperature combusted gas remaining in the cylinder reduces.

On the other hand, in the present embodiment, the piston position at the intake (exhaust) top dead center is set to the lower position than the compression top dead center, which contributes to an increase in the volume in the combustion chamber from the terminal stage of the exhaust stroke to the initial stage of the intake stroke and thus an increase in the amount of the high-temperature remaining exhaust gas, thereby succeeding in keeping the temperature in the combustion chamber at a high temperature and sufficiently acquiring the internal EGR effect. Especially in the cold operation state in which the temperature in the combustion chamber is low, the temperature in the combustion chamber and the temperature of the gas in the cylinder can increase due to the large amount of remaining exhaust gas, which brings about a high effect of being able to reduce the exhaust emission.

In the above-described manner, the following special effects can be acquired by setting the piston position at the intake (exhaust) top dead center to the lower position than the piston position at the compression top dead center.

That is, the piston position is located at a position as high as the piston position at the compression top dead center (Y0), so that, for example, the mechanical compression ratio C or the mechanical expansion ratio E can be set to a high ratio, whereby various engine performances can be sufficiently enhanced. In addition, even when the piston position is set to such a high piston position, the intake valve IV and the exhaust valve EV are not activated (do not increase the lift) and continue the closed state at the compression top dead center, which prevents the occurrence of the problem of the interference between the piston, and the intake vale IV and the exhaust valve EV in principle.

On the other hand, regarding the intake (exhaust) top dead center, the exhaust valve EV is activated to be closed and the intake valve IV is activated to be opened around there, so that these intake valve IV and exhaust valve EV and the piston 2 may mechanically interfere with each other if the piston position is located at a high position like the compression top dead center (Y0). However, each of the piston positions at the intake (exhaust) top dead center (Y′03 and Y′04) is located at the lower position than the piston position at the compression top dead center (Y0) as described above, so that such mechanical interference can be avoided.

Especially, setting each of the piston positions at the intake (exhaust) top dead center (Y′03 and Y′04) to the lower position than the lift position where the lift amount of the intake valve IV is maximized (yi max) and the lift position where the lift amount of the exhaust valve EV is maximized (ye max) can bring about such a special effect that the interference between the intake/exhaust valve and the piston can be prevented regardless of this phase even when a failure has occurred in the above-described control of the opening/closing phase of the intake/exhaust valve.

Further, each of the piston positions at the intake (exhaust) top dead center (Y′03 and Y′04) is set to the lower position than the piston position at the compression top dead center (Y0), which contributes to the increase in the volume in the combustion chamber at the terminal stage of the exhaust stroke or the initial stage of the intake stroke and thus the increase in the amount of the high-temperature remaining exhaust gas in the cylinder, thereby succeeding in keeping the temperature of the gas in the combustion chamber and the cylinder at the high temperature and sufficiently acquiring the so-called internal EGR effect. Especially in the cold operation state in which the temperature in the combustion chamber and the temperature of the air-fuel mixture are low, the temperature in the combustion chamber and the temperature of the introduced air-fuel mixture can increase due to the large amount of remaining exhaust gas, which brings about the high effect of being able to reduce the exhaust emission.

Then, the piston position at the intake (exhaust) top dead center is located at the slightly lower position in the control phase α3 than the control phase α4 as described above, and according thereto, the following effects can be further acquired. That is, in this control phase α3, the characteristic of the change in the piston position is set to a commonly-seen characteristic in which the compression stroke LC3 and the expansion stroke LE3 are the same, i.e., the relationship between the ratios is the mechanical compression ratio C3=the mechanical expansion ratio E3, and, further, the intake stroke LI3 and the exhaust stroke L03 are the same.

This commonly-seen characteristic is expected to be used in a wide rotational band including the high rotation although being difficult to achieve the effect of reducing the exhaust emission at the time of the cold operation like the above-described control phase α4. This is because, at the time of the high rotation, the exhaust valve EV and the intake valve IV are prone to the occurrence of the abnormal motion such as the jump and the bounce as described above, but the piston position at the intake (exhaust) top dead center (Y′03) is located at the slightly lower position in the control phase α3, so that the interference between the piston, and the intake valve IV and the exhaust valve EV can be reliably prevented even in this case. In the above-described manner, the present embodiment allows the mechanical interference between the piston, and the intake valve IV and the exhaust valve EV from being prevented throughout the range from the control phase α3 to the control phase α4, which is a control range. In addition, in the control phase α3 that may be used in the wide rotational band, this mechanical interference can be further effectively prevented.

Further, in the present embodiment, as illustrated in FIG. 2, the vane-type piston position change mechanism 6 is installed on the large-diameter second gear wheel 16 on the speed reduction side with respect to the first gear wheel 15 as illustrated in FIG. 2. Therefore, the present embodiment allows the vane diameter or the like to be set to a larger diameter compared to the piston position change mechanism 6 installed on the small-diameter first gear wheel 15 on the crank side, and therefore can enhance vane conversion power and can also improve conversion responsiveness and increase a load resistance capability.

In the above-described manner, according to the present embodiment, the piston position at the intake (exhaust) top dead center is set to the lower position compared to the piston position at the compression top dead center by the variable compression ratio mechanism, which allows the variable compression ratio mechanism 1 to prevent the crown surface of the piston and the intake/exhaust valve from interfering with each other, or sufficiently acquire the internal EGR effect.

### Second Embodiment

Next, a second embodiment of the present invention will be described. In the first embodiment, the relative phase between the vane and the control shaft is controlled between the control phase α3 and the control phase α4, and the second embodiment is different therefrom in terms of controlling the relative shaft between the vane and the control shaft between the control phase α2 and the control phase α3.

The conversion angle αT illustrated in FIGS. 3(A) and 3(B) is set to α3−α2 (for example, 222 degrees−180 degrees=42 degrees), and the vane is biased by the biasing spring, which biases the vane toward the delay angle side. Then, the vane conversion angle is enlarged compared to the first embodiment, and the vane conversion angle can be enlarged by lightning a portion around a stopper portion of the housing and a side surface portion of the vane. Further, the conversion angle can also be enlarged by reducing the number of vanes from four vanes to three vanes. Then, the intended conversion can be achieved by setting the attachment phase between the vane and the control shaft in such a manner that the maximum delay angle position where the delay angle-side stopper and the vane are in abutment with each other (the default position) matches the position in a3 illustrated in FIGS. 4(A) to 4(D).

Reducing the number of vanes according to the enlargement of the vane conversion angle in this manner may raise a risk of a reduction in the converted power due to the hydraulic pressure of the vane-type piston position change mechanism 6, and deterioration of the conversion responsiveness. However, the vane-type piston position change mechanism 6 is installed on the second gear wheel 16 on the speed reduction side as described above, which even allows the vane diameter or the like to be appropriately set to a large diameter. As a result, the present embodiment can secure the vane conversion power by the piston position change mechanism 6, thereby preventing or reducing the deterioration of the conversion responsiveness and the deterioration of a vane holding capability.

FIG. 7 illustrates a characteristic of the change in the piston position. A solid line represents the same characteristic as the control phase α3 illustrated in FIG. 4(C) according to the first embodiment (the α3 characteristic), but this characteristic is used as the characteristic when the vane rotor 21 is located at the maximum delay angle (default) position according to the present embodiment. Further, an alternate long and short dash line illustrated in FIG. 7 represents a characteristic of the control phase α2 illustrated in FIG. 4(B) (an α2 characteristic), and this characteristic is used as the characteristic when the vane rotor 21 is located at the maximum advance angle position according to the second embodiment.

In the control phase α2 illustrated in FIG. 4(B), a position of the piston at the compression top dead center (Y02) is also approximately the same as the above-described position Y0, but a position at the intake bottom dead center and a position at the expansion bottom dead center are different from the control phase α3.

More specifically, as illustrated in FIG. 7, because the dimensional relationship is LC2<LE2, the relationship between the ratios is a mechanical compression ratio C2<a mechanical expansion ratio E2 and a relative ratio D2 is D2=LE2÷LC2>1, which means that the mechanical expansion ratio is relatively higher than the mechanical compression ratio.

Further, comparing the control phase α2 with the control phase α3, the mechanical compression ratio is lower like C2<C3, and the mechanical expansion ratio is higher like E2>E3.

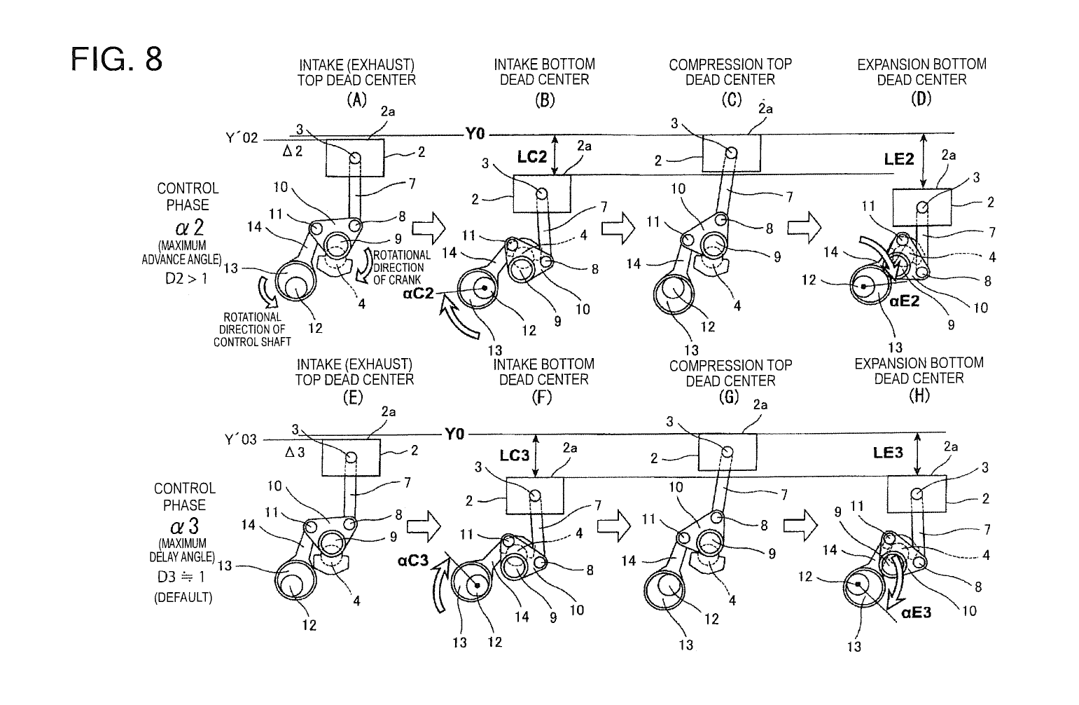

FIGS. 8(A) to 8(D) illustrate a change in the posture of the mechanism in the control phase α2. As described above, the dimensional relationship is LC2<LE2, so that the relationship between the mechanical ratios is the mechanical compression ratio C2<the mechanical expansion ratio E2, i.e., the relative ratio D2 is D2>1. Then, comparing the control phase α2 with the control phase α3 illustrated in FIGS. 8(E) to 8(H), the dimensional relationships are LC2<LC3 and LE2>LE3.

A reason why the variable compression ratio mechanism 1 has such a characteristic will be described now. Comparing eccentric rotational directions αC of the eccentric cam portion 13 at the posture at the intake bottom dead center illustrated in FIGS. 8(B) and 8(F), αC2 in the control phase α2 illustrated in FIG. 8(B) is out of phase with aC3 in the control phase α3 illustrated in FIG. 8(F) in the counterclockwise direction (the advance angle direction).

In other words, the center of the eccentric circle is displaced to the lower left, which causes the control link 14 to relatively pull down the second coupling pin 11 to the lower left, thereby rotating the lower ling 10 in the counterclockwise direction with use of the crank pin 9 as a supporting point. Due to this operation, the position of the first coupling pin 8 is raised, and thus the piston 2 is pushed up by the upper link 7. As a result, the lengths have the relationship LC2<LC3.

On the other hand, focusing on eccentric rotational directions αE of the eccentric cam portion 13 at the posture at the expansion bottom dead center illustrated in FIGS. 8(D) and 8(H), αE2 in the control phase α2 illustrated in FIG. 8(D) is also out of phase with αE3 in the control phase α3 illustrated in FIG. 8(H) in the counterclockwise direction (the advance angle direction).

In other words, the center of the eccentric circle is relatively displaced upward, which causes the control link 14 to push up the second coupling pin 11 to the upper right, thereby rotating the lower link 10 in the clockwise direction with use of the crank pin 9 as a supporting point. Due to this operation, the position of the first coupling pin 8 is lowered, and thus the piston is pulled down by the upper link 7. As a result, the lengths have the relationship LE2>LE3.

In other words, the difference in the characteristic of the change in the piston position between the control phase α3 and the control phase α2 illustrated in FIG. 7 is generated due to the difference in the link postures that is caused by the difference in the eccentric rotational direction of the eccentric camp portion 13 illustrated in FIGS. 8(A) to 8(H).

Next, effects regarding the engine performance according to the present embodiment will be described.

After the warm-up of the engine, the vane rotor 21 of the piston position change mechanism 6 is converted into the maximum advance angle position due to the control hydraulic pressure from the electromagnetic switching valve 32, and the control is switched to the control phase α2. This phase brings about such a characteristic that the mechanical compression ratio C2 is low and the mechanical expansion ratio E2 is high. Now, the high mechanical expansion ratio E2 allows the variable compression ratio mechanism 1 to increase work performed by pulling down the piston with use of a combustion pressure (expansion work), thereby improving the fuel efficiency in, for example, the partial load operation region.

On the other hand, in such a partial load operation region after the warm-up of the engine, the high mechanical compression ratio leads to such a risk that the temperature of the gas in the cylinder at the compression top dead center increases and thus the cooling loss undesirably increases. However, since the mechanical compression ratio C2 relatively reduces like the present embodiment, the fuel efficiency (thermal efficiency) can be further improved by preventing or reducing the generation of such a cooling loss.

Further, abnormal combustion such as knocking easily occurs due to this high mechanical compression ratio in the engine high load state, but the reduction in the mechanical compression ratio allows the variable compression ratio mechanism 1 to also avoid this possibility. Then, the technique discussed in the above-described patent literature, PTL 1 (Japanese Patent Application Public Disclosure No. 2002-276446) can also prevent the knocking by controlling the mechanical compression ratio so as to reduce it, but this technique also undesirably reduces the mechanical expansion ratio according thereto, which is accompanied by a reduction in the fuel efficiency and a torque reduction due to a reduction in the expansion work. Further, this technique also involves such a drawback that the catalyst is undesirably thermally deteriorated according to an increase in the temperature of the exhaust due to the reduction in the mechanical expansion ratio. On the other hand, according to the present embodiment, these drawbacks can be avoided due to the high mechanical expansion ratio.

Then, in the present embodiment, if the variable compression ratio mechanism 1 has such a characteristic of the change in the piston position even at the time of the cold operation, inconvenience would occur in terms of the exhaust emission. More specifically, since the mechanical expansion ratio E2 is high, the temperature of the exhaust gas emitted from the main body of the engine undesirably reduces by a degree corresponding to the increase in the expansion work, which impedes warm-up of the downstream catalyst, thereby reducing a performance of converting the exhaust emission by the catalyst.

Further, since the mechanical compression ratio is low, the gas in the cylinder also has a relatively low temperature at the compression top dead center at the time of the cold operation, and the combustion is insufficient at the time of the cold operation, so that the emission emitted from the main body of the engine itself also increases. For the above-described two reasons, the exhaust emission undesirably increases from the tailpipe downstream of the catalyst into the air.

Therefore, in the present embodiment, the characteristic of the change in the piston position is set to the normal characteristic like the control phase α3 at the time of the cold operation. By this setting, the present embodiment can acquire the above-described effect of improving the fuel efficiency and the like by converting the control phase to the control phase α2 after the warm-up while avoiding the increase in the exhaust emission emitted into the air at the time of the cold operation.

When the engine has a temperature between the temperature at the time of the cold operation and the temperature after the warm-up (a temperature in the middle of the warm-up), the rotational phase of the vane rotor 21 of the piston position change mechanism 6 is controlled, and the control phase is controlled so as to shift toward the control phase α3 as the temperature reduces and shift toward the control phase α2 as the temperature increases. As a result, the fuel efficiency and the exhaust emission performance can be appropriately balanced for each temperature. For example, the fuel efficiency can be improved as much as possible while the exhaust emission is reduced.

In both the control phase α2 and the control phase α3, the characteristic of the change in the piston position is set to such a characteristic that a periodic operation is performed based on one cycle set to the crank angle 720 degrees as described above, and two top dead centers occur at the positions where the crank angle is around 0 degrees (720 degrees) and 360 degrees. Each of the top dead centers around the crank angle 360 degrees (Y02 and Y03) corresponds to the compression top dead center where both the intake valve and the exhaust valve are completely closed, and is located at an actually approximately same position as the above-described position, Y0. On the other hand, the top dead center around the crank angle 0 degrees corresponds to the intake (exhaust) top dead center where the exhaust valve is closed and the intake valve starts operating around there, and the respective piston positions there are Y′02 and Y′03, respectively.

Each of the piston positions at this intake (exhaust) top dead center (Y′02 and Y′03) is located at a lower position than the piston position at the compression top dead center (Y0). This is because the crank pin 9, the first coupling pin 8, and the piston pin 3 are not arranged in one straight line but are arranged in a left dogleg-like bent shape and this arrangement causes the piston position to be located at the lower position than the above-described piston position at the compression top dead center (Y0) in both the control phase α2 and the control phase α3 as indicated by the postures at the intake (exhaust) top dead center illustrated in FIGS. 8(A) and 8(E).

Then, focusing on this intake (exhaust) top dead center, in the case of the present embodiment, the eccentric direction of the eccentric cam portion 13 with respect to the control link 14 is in an approximately linear relationship between the control phase α2 and the control phase α3 as seen from a comparison between FIGS. 8(A) and 8(E). Therefore, the opening angle itself is similar. Therefore, the position of the second pin 11 is not changed so much between the control phase α2 and the control phase α3. For this reason, the respective piston positions at the intake (exhaust) top dead center, which correspond to the piston position in the control phase α2 (Y′02 and lowered by Δ2) and the piston position in the control phase α3 (Y′03 and lowered by Δ3), are located at approximately same positions as each other.

In this manner, each of the piston positions at the intake (exhaust) top dead center (Y′02 and Y′03) is located at the lower position than the piston position at the compression top dead center (Y0) and is also located at the approximately same position as each other, which is extremely advantageous in terms of the mechanical interference between the piston 2, and the intake vale IV and the exhaust valve EV even in a case where, for example, a controller malfunctions as will be described below. In both the control phase α2 and the control phase α3, the position of the crown surface of the piston 2 (Y) is sufficiently downwardly separated from the intake valve lift position (yi) of the intake valve IV and the exhaust valve lift position (ye) of the exhaust valve Ev in terms of the crank angle around the intake (exhaust) top dead center illustrated in FIG. 7, which makes the occurrence of the interference difficult similarly to the first embodiment.

Therefore, for example, at the time of the high rotation, the intake valve IV and the exhaust valve EV are prone to the occurrence of the abnormal motion such as the jump and the bounce, but the interference can be sufficiently prevented even in this case similarly to the first embodiment. Further, in the case where the internal combustion engine is provided with the variable valve actuating mechanism capable of controlling the opening/closing phase of the intake valve IV and the exhaust valve EV and changing the lift amount itself so as to increase it, which has been being widely used in recent years, the mechanical interference between the intake valve IV and the exhaust valve EV, and the piston easily occurs. Even in such a case, the employment of the variable compression ratio mechanism according to the present embodiment allows the intake valve IV and the exhaust valve EV, and the piston to effectively prevent the mechanical interference therebetween similarly to the first embodiment.

Then, hypothetically supposing that the settings of the operation timings of the intake valve IV and the exhaust valve EV shift by approximately 360 degrees as the crank angle, there is raised such a problem that the high piston position (Y0) is located at the piston position at the intake (exhaust) top dead center and the interference allowance between the intake valve lift curve (yi) and the exhaust valve lift curve (ye) at each of the crank angles indicated by a broken line in FIG. 7, and the position Y of the crown surface of the piston reduces, whereby the intake valve IV and the exhaust valve EV easily interfere with the piston at the time of the abnormal motion thereof such as the jump and the bounce.

Further, as another problem than that, the piston is raised to a high position and the volume in the combustion chamber reduces from the terminal stage of the exhaust stroke to the initial stage of the intake stroke as described above, so that the amount of high-temperature remaining combusted gas reduces, which makes it impossible to acquire the above-described internal EGR effect, i.e., makes it difficult to acquire, for example, the above-described effect of reducing the emission at the time of the cold operation and effect of improving the fuel efficiency after the warm-up.

On the other hand, in the present embodiment, the piston position at the intake (exhaust) top dead center is set to the lower position than the compression top dead center, which contributes to an increase in the volume in the combustion chamber from the terminal stage of the exhaust stroke to the initial stage of the intake stroke and thus an increase in the amount of the high-temperature exhaust gas remaining in the cylinder, thereby succeeding in keeping the temperature in the combustion chamber and the temperature of the gas in the cylinder at high temperatures and sufficiently acquiring the internal EGR effect. For example, in the operation state in which the temperature in the combustion chamber and the temperature of the air-fuel mixture are low, these temperatures can increase due to the large amount of remaining exhaust gas, which brings about a high effect of being able to reduce the exhaust emission. Further, even after the warm-up, the combustion is improved in the partial load region due to this internal EGR effect, and, further, the pump loss reduces due to that, so that the fuel efficiency effect can also be further enhanced.

Further, the following special effects can be acquired by raising the piston position at the compression top dead center and setting the piston position at the intake (exhaust) top dead center to the low position like the present embodiment.

That is, the piston position at the compression top dead center is located at the piston position as high as the piston position (Y0), so that the mechanical compression ratio C or the mechanical expansion ratio E can be set to a high ratio, whereby various engine performances can be sufficiently enhanced. For example, the fuel efficiency effect can be further more enhanced due to the high mechanical expansion ratio E in the partial load region. In addition, even when the piston position is set to such a high piston position, the intake valve IV and the exhaust valve EV are not activated (do not increase the lift) and continue the closed state at the compression top dead center, which prevents the occurrence of the problem of the interference between the piston, and the intake vale IV and the exhaust valve EV in principle.

On the other hand, regarding the intake (exhaust) top dead center, the exhaust valve EV is activated to be closed and the intake valve IV is activated to be opened around there, so that these intake valve IV and exhaust valve EV, and the piston may mechanically interfere with each other if the piston position is located at a high position like the piston position at the compression top dead center (Y0). However, the piston position at the intake (exhaust) top dead center (Y′02 and Y′03) is located at the lower position than the piston position at the compression top dead center (Y0) as described above, so that such mechanical interference can be avoided.

Further, the piston position at the intake (exhaust) top dead center is set to the lower position than the compression top dead center, which contributes to the increase in the volume in the combustion chamber at the terminal stage of the exhaust stroke and thus the increase in the amount of the high-temperature remaining exhaust gas, thereby succeeding in keeping the temperature in the combustion chamber at the high temperature and sufficiently acquiring the internal EGR effect. For example, in the operation state in which the temperature in the combustion chamber is low, the temperature in the combustion chamber can be kept at the high temperature due to the large amount of remaining exhaust gas, which brings about the high effect of being able to reduce the exhaust emission. Further, even after the warm-up, the combustion is improved in the partial load region due to this internal EGR effect, and, further, the pump loss reduces due to that, so that the fuel efficiency effect can also be further enhanced.

Then, the piston position at the intake (exhaust) top dead center (Y′02 and Y′03) is located at the approximately same position between the control phase α2 and the control phase α3 as described above, so that the following effects can be further acquired. That is, the interference allowance is approximately the same between the control phase α2 and the control phase α3. Then, the interference allowance is also approximately the same in a control angular range within a range between the control phase α2 and the control phase α3. Therefore, the interference allowance is approximately the same throughout the variable control range.

Therefore, when a failure has occurred in the controller and an abnormality has occurred in the control of the piston stroke (the control of the a angle) like the present embodiment, the interference allowance is approximately the same regardless of the control position. Therefore, even at the time of the abnormality such as the failure in the controller, the risk of the mechanical interference between the piston, and the intake valve and the exhaust valve can be avoided. Further, even when over revolution (an excessive rotation) has occurred due to, for example, a shift error by a driver, the occurrence of the mechanical interference between the piston, and the intake valve and the exhaust valve can be also prevented or reduced.

### Third Embodiment

Next, a third embodiment of the present invention will be described. The relative phase between the vane and the control shaft is controlled between the control phase o3 and the control phase α4 in the first embodiment, and is controlled between the control phase α2 and the control phase α3 in the second embodiment. The third embodiment is different therefrom in terms of controlling the relative phase between the vane and the control shaft between the control phase α1 and the control phase α4.

The conversion angle αT illustrated in FIGS. 3(A) and 3(B) is further enlarged to α4−α1 (for example, 240 degrees −137 degrees=103 degrees). The conversion angle may be enlarged by reducing the number of vanes 27 from four vanes to two vanes, but the present embodiment employs a mechanism using an electric method like mechanisms discussed in Japanese Patent Application Public Disclosure No. 2012-197755 (PTL 2) and Japanese Patent Application Public Disclosure No. 2012-180816 (PTL 3) as the piston position change mechanism.

According to the piston position change mechanisms discussed in the above-described two patent literatures, PTLs 2 and 3, these mechanisms are configured to convert the phase between a camshaft and a timing sprocket by a rotation of an electric motor via a speed reduction mechanism. On the other hand, in the present embodiment, the piston position change mechanism uses the control shaft 12 instead of this camshaft and the second gear wheel 16 instead of the timing sprocket. Configuring the piston position change mechanism in this manner eliminates a constraint on the conversion angle from the mechanical layout, such as interference between the vane and the housing, and allows pivotal movements of the maximum delay angle and the maximum advance angle to be regulated only by a relationship between a protruding portion of the stopper and a recessed portion of the stopper as discussed in the two patent literatures, PTLs 2 and 3.

In the present embodiment, by this configuration, the phase of the maximum advance angle of the output shaft of the electric piston position change mechanism is set to the control phase α1, and the phase of the maximum delay angle thereof is set to the control phase α4. Further, a biasing member for biasing the control shaft 12 in the delay angle direction is also provided similarly to the first embodiment and the second embodiment.

FIG. 9 illustrates a characteristic of the change in the piston position. A broken line represents the characteristic (the maximum delay angle) in the control phase α4, which is the same characteristic as the control phase α4 illustrated in FIG. 5 according to the first embodiment. A solid line represents the characteristic (the maximum advance angle) in the control phase α1, which corresponds to the control phase α1 illustrated in FIGS. 4(A) to 4(D).

As understood from this drawing, FIG. 9, in the characteristic of the change in the piston position in the control phase α1, the compression stroke LC1 is sufficiently short, and the expansion stroke LE1 is sufficiently long. Therefore, the mechanical compression ratio C1 is sufficiently low and the mechanical expansion ratio E1 is sufficiently high, so that the relative radio D1 (E1÷C1) has a high value sufficiently exceeding 1.

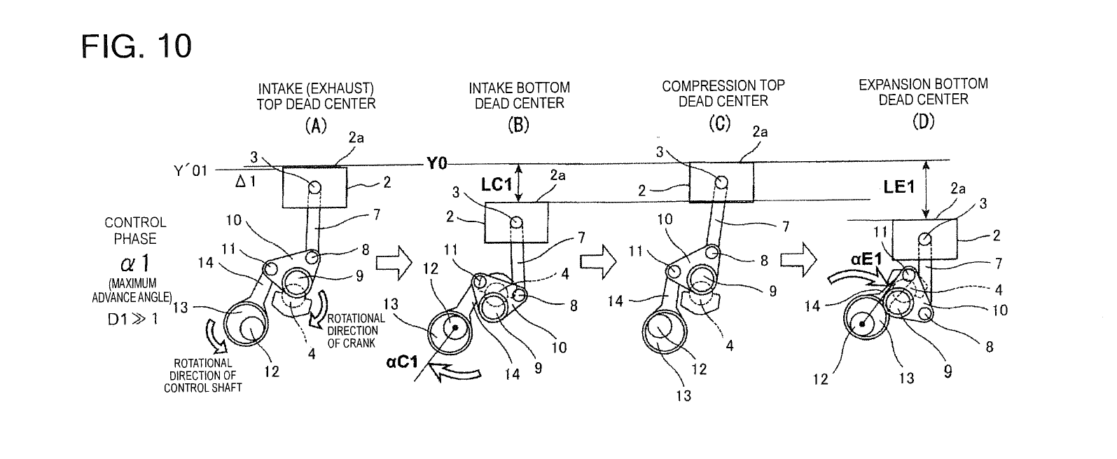

FIGS. 10(A) to 10(D) illustrate a change in the posture of the mechanism in the control phase α1, and FIGS. 10(A) to 10(D) illustrate the postures at the intake (exhaust) top dead center, the intake bottom dead center, the compression top dead center, and the expansion bottom dead center, respectively, similarly to FIGS. 6(A) to (6H) and 8(A) to 8(H).

Focusing on the eccentric rotational direction αC1 of the eccentric cam portion 13 at the posture at the intake bottom dead center illustrated in FIG. 10(B), this direction is oriented in an approximately opposite direction from the direction of the control link 14. Therefore, the control link 14 and the second coupling pin 11 are approximately maximally pulled down in the lower left direction, and the phase of the lower link 10 is approximately maximally changed around the crank pin 9 in the counterclockwise direction. According thereto, the first coupling pin 8 is approximately maximally displaced upward, and thus the piston 2 is approximately maximally pushed upward by the upper link 7.

As a result, the lengths have a relationship LC1<LC2<LC3<LC4, as LC1 is sufficiently short and is approximately minimized. On the other hand, focusing on the eccentric rotational direction αE1 of the eccentric cam portion 13 at the posture at the expansion bottom dead center illustrated in FIG. 10(D), this direction is oriented in an approximately same direction as the direction of the control link 14.

Therefore, the control link 14 and the second coupling pin 11 are approximately maximally pushed up to the upper right direction, and the phase of the lower link 10 is approximately maximally changed around the crank pin 3 in the clockwise direction. According thereto, the first coupling pin 8 is approximately maximally displaced downward, and thus the piston 2 is approximately maximally pushed down by the upper link 7. As a result, the lengths have a relationship LE1>LE2>LE3>LE4, as LE1 is sufficiently long and is approximately maximized.

In other words, the relative ratios have a relationship D1>D2>D3>D4, as the relative ratio D1 (=LE1/LC1) is also sufficiently high and is approximately maximized. These characteristics are generated due to the difference between the link postures that is caused by the eccentric rotational direction of the eccentric cam portion 13 as described above.

Next, effects regarding the engine performance according to the present embodiment will be described.

For example, at the time of the partial load operation after the completion of the warm-up of the internal combustion engine, the eccentric cam portion 13 is converted into the maximum advance angle position by the electric piston position change mechanism, and the variable compression ratio mechanism 1 is controlled so as to have such a characteristic that the mechanical compression ratio C1 is sufficiently and approximately maximally low and the mechanical expansion ratio E1 is sufficiently and approximately maximally high in the control phase α1. Then, since the mechanical expansion ratio E1 is approximately maximally high, the variable compression ratio mechanism 1 can approximately maximally increase the work performed by pushing down the piston with use of the combustion pressure.

On the other hand, at the time of such partial load operation after the completion of the warm-up, there is such a risk that the temperature of the gas in the cylinder at the compression top dead center excessively increases and the cooling loss undesirably increases. However, the mechanical compression ratio C1 can be approximately maximally reduced, like the present embodiment, so that the occurrence of such a cooling loss can be sufficiently prevented or reduced.

Further, the present embodiment can sufficiently improve the fuel efficiency due to the approximately maximized mechanical expansion ratio E1 while sufficiently preventing or reducing the abnormal combustion such as the knocking in the engine high load state due to the approximately minimized mechanical compression ratio C1. Further, the present embodiment can sufficiently reduce the temperature of the exhaust gas (the high-temperature exhaust gas at the time of the high load) due to the approximately maximized mechanical expansion ratio E1, thereby sufficiently preventing or reducing the thermal deterioration of the catalyst.

Due to the sufficient expansion work and the reduction in the cooling loss in the above-described manner, the present embodiment can sufficiently improve the fuel efficiency (the thermal efficiency) in the partial load operation after the completion of the warm-up, and prevent the thermal deterioration of the catalyst by further sufficiently reducing the temperature of the exhaust gas in the high load operation. Then, focusing on the relative ratio D1 (=E1÷C1), the relative ratio D1 has the high value sufficiently exceeding 1 as described above. A higher value as this relative ratio D1 means that the mechanical expansion ratio is relatively high and the mechanical compression ratio is relatively low, and the relative ratio D1 can be regarded as the index indicating the effectiveness of the above-described effect for the fuel efficiently performance and the like.

On the other hand, if the variable compression ratio mechanism 1 has such a characteristic of the change in the piston position (the approximately minimized mechanical compression ratio, the approximately maximized mechanical expansion ratio, and the approximately maximized relative ratio) at the ° time of the cold operation, serious inconvenience would occur in terms of the exhaust emission. More specifically, since the mechanical expansion ratio E1 is approximately maximized, the temperature of the exhaust gas emitted from the main body of the engine undesirably excessively reduces by a degree corresponding to the sufficient increase in the expansion work, which impedes warm-up of the downstream catalyst, thereby significantly reducing the performance of converting the exhaust emission.

Further, since the mechanical compression ratio is approximately minimized, the temperature of the gas in the cylinder at the compression top dead center also excessively reduces and the combustion is significantly deteriorated at the time of the cold operation, and the emission emitted from the main body of the engine also significantly increases. This leads to a significant increase in the exhaust emission of the exhaust gas emitted from the tailpipe downstream of the catalyst into the air.

Therefore, at the time of the cold operation, conversely, the characteristic of the change in the piston position is converted into such a characteristic that the mechanical compression ratio C is high and the mechanical expansion ratio E is low like the control phase α4. By this conversion, the present embodiment can considerably reduce the exhaust emission emitted into the air and also more reduce the exhaust emission than the standard normally-seen characteristic of the change in the piston position (for example, the characteristic in which the relationship between the ratios is the mechanical compression ratio C=the mechanical expansion ratio E, like the control phase α3), due to the effects of improving the combustion and increasing the temperature of the exhaust gas, similarly to the first embodiment. In other words, the relative ratio D4 is a value lower than 1. A lower value as this ratio means that the expansion ratio is relatively low and the compression ratio is relatively high, and the relative ratio D4 can be regarded as the index indicating the excellence of the exhaust emission performance as described above.

In the above-described manner, the present embodiment can approximately maximally improve the fuel efficiency after the warm-up, and also reduce the exhaust emission at the time of the cold operation similarly to the first embodiment. This effect is restated as increasing the relative ratio to D1 higher than 1 after the warm-up to enhance the fuel efficiency effect and reducing the relative ratio to D4 lower than 1 at the time of the cold operation to improve the exhaust emission at the time of the cold operation.

When the engine has a temperature between the temperature at the time of the cold operation and the temperature after the completion of the warm-up (a temperature in the middle of the warm-up), the phase of the output shaft (the phase of the eccentric cam portion 13) of the electric piston position change mechanism is controlled to the large conversion angle, and the control phase is controlled so as to shift toward the control phase α4 as the temperature reduces and shift toward the control phase α1 as the temperature increases.

As a result, the fuel efficiency performance and the emission performance can be appropriately balanced for each temperature. In this case, the present embodiment employs the electric piston position change mechanism insusceptible to the temperature and capable of achieving a highly responsive conversion, which allows the variable compression ratio mechanism 1 to acquire a stable effect without a conversion delay compared to the hydraulic piston position change mechanism. For example, the present embodiment can maximally improve the fuel efficiency while stably reducing the exhaust emission for each change in the temperature.

Further, the present embodiment can improve various engine performances by achieving the high responsiveness and the position control based on the large conversion angle due to the electric piston position change mechanism even in a transient operation state, thereby improving a transient torque at the time of, for example, sudden acceleration.

Further, the present embodiment can improve a knocking resistance capability due to the reduction in the mechanical compression ratio as described above, but the intake stroke (≈the compression stroke) tends to reduce according to the reduction in the mechanical compression ratio, so that the charging efficiency may undesirably reduce.

Therefore, the variable compression ratio mechanism 1 should improve the charging efficiency maximally as much as possible while preventing or reducing the knocking to improve the transient torque, and therefore may be required to appropriately perform correction control on the mechanical compression ratio so as to allow the transient torque to be maximized quickly in acceleration transition.

Then, in a case of use of a supercharger such as a turbocharger, which has been being increasingly used in recent years, a supercharging pressure is also subjected to a transient change, and therefore large knocking tends to easily occur. Therefore, the variable compression ratio mechanism 1 may be required to control the mechanical compression ratio to quickly achieve a ratio capable of increasing the charging efficiency maximally as much as possible while preventing or reducing the knocking also in consideration thereof.

To address these requests, the present embodiment employs the electric piston position change mechanism as described above, which allows the variable compression ratio mechanism 1 to achieve the highly responsive conversion regardless of the engine hydraulic pressure and the engine temperature, thereby sufficiently acquiring an effect of improving the transient torque.

Further, for example, even when the engine shifts to the low load region after reaching the high load region by the acceleration in this manner, the mechanical compression ratio can be quickly changed to the high ratio due to the electric piston position change mechanism, which allows the variable compression ratio mechanism 1 to also acquire the fuel efficiency effect swiftly.

In the above-described manner, the present embodiment allows the variable compression ratio mechanism 1 to improve the various engine performances by causing the piston position change mechanism for the large conversion angle to operate with high responsiveness.

Further, in both the control phase α1 and the control phase α4, the characteristic of the change in the piston position is set to such a characteristic that a periodic operation is performed based on one cycle set to the crank angle 720 degrees as described above, and two top dead centers occur at the positions where the crank angle is around 0 degrees (720 degrees) and 360 degrees, similarly to the first embodiment and the second embodiment. The top dead center around the crank angle 360 degrees corresponds to the compression top dead center where both the intake valve and the exhaust valve are completely closed, and the piston position at the compression top dead center is also located at an approximately same position as the above-described position, Y0. On the other hand, the top dead center around the crank angle 0 degrees corresponds to the piston position at the intake (exhaust) top dead center (Y′01 and Y′04) where the exhaust valve is closed and the intake valve starts operating.

Each of the piston positions at this intake (exhaust) top dead center (Y′01 and Y′04) is located at the lower position than the piston position at the compression top dead center (Y0). This is because the crank pin 9, the first coupling pin 8, and the piston pin 3 are not arranged in one straight line but are arranged in a left dogleg-like bent shape and this arrangement causes the piston position to be located at the lower position than the above-described piston position at the compression top dead center (Y0) in both the control phase α1 and the control phase α4 as indicated by the postures at the intake (exhaust) top dead center illustrated in FIGS. 10(A) and 6(A).

However, in the case of the present embodiment, the eccentric direction of the eccentric cam portion 13 with respect to the control link 14 is different between the control phase α1 and the control phase α4. Now, the opening angle itself is larger and close to 180 degrees in the control phase α1. Therefore, the piston position at the intake (exhaust) top dead center in the control phase α1 (Y′01 and lowered by Δ1) is located at a slightly higher position than the piston position in the control phase α4 (V′04 and lowered by Δ4) but is located at a sufficiently lower position than the piston position at the compression top dead center (Y0).

Focusing on the change in the piston position at the intake (exhaust) top dead center during the shift from the control phase α1 to the control phase α4, the piston is located at the piston position (Y′01 and lowered by Δ1), the piston position (Y′02 and lowered by 62), the piston position (Y′03 and lowered by 63), and the piston position (Y′04 and lowered by Δ4), which means that the piston position is located at a lower position than the piston position at the compression top dead center (Y0) throughout the entire control range.

Therefore, for example, at the time of the high rotation, the intake valve IV and the exhaust valve EV are prone to the occurrence of the abnormal motion such as the jump and the bounce, but the intake value IV and the exhaust valve EV, and the piston can be sufficiently prevented from interfering with each other even in this case. Further, in the case where the internal combustion engine is provided with the variable valve actuating mechanism capable of controlling the opening/closing phase of the intake valve IV and the exhaust valve EV and changing the lift amount itself so as to increase it, which has been being widely used in recent years, the mechanical interference between the intake valve IV and the exhaust valve EV, and the piston easily occurs. Even in such a case, the employment of the variable compression ratio mechanism according to the present embodiment allows the intake valve IV and the exhaust valve EV, and the piston to effectively prevent the mechanical interference therebetween. In addition, these effects can be acquired throughout the entire control range.

Further, in the present embodiment, the piston position at the intake (exhaust) top dead center is set to the lower position than the piston position at the compression top dead center, which contributes to the increase in the volume in the combustion chamber during the exhaust stroke and thus the increase in the amount of the high-temperature remaining exhaust gas, thereby succeeding in keeping the temperature in the combustion chamber at the high temperature and sufficiently acquiring the internal EGR effect. For example, in the operation state in which the temperature in the combustion chamber is low, the temperature in the combustion chamber can be kept at the high temperature due to the large amount of remaining exhaust gas, which brings about the high effect of being able to reduce the exhaust emission.

Further, focusing on details, piston positions at the intake (exhaust) top dead center at an ultralow mechanical expansion ratio and an ultrahigh mechanical compression ratio in the control phase α1 (Y′01 and lowered by Δ1) are each located at a lower position than the piston position at the compression top dead center (Y0) as described above but is located at a highest position in the entire control range. As a result, the following effects can be acquired.

That is, the control phase α1 includes the ultralow mechanical compression ratio and the ultrahigh mechanical expansion ratio and achieves the high fuel efficiency effect, but tends to cause a reduction in the intake stroke according to the reduction in the compression stroke LC1. This may lead to such a problem that an amount of introduced air is unintentionally limited, which makes it difficult to expand the control region of the control phase α1 where the fuel efficiency is excellent toward the high load (high torque) side.

On the other hand, in the present embodiment, the piston position at the intake (exhaust) top dead center (Y′01) is set to a slightly higher position, which slightly increases the intake stroke to LI1 and thus allows the control region of the control phase α1 where the fuel efficiency is excellent to be expanded toward the high load (high torque) side.

On the other hand, the control based on the control phase α1 is not used in an extremely high rotation region in the first place due to the above-described limitation on the amount of introduced air, so that the mechanical interference between the intake valve IV and the exhaust valve EV, and the piston can be effectively prevented even without the piston position at the intake (exhaust) top dead center (Y′01) placed at an extremely lower position than the piston position at the compression top dead center (Y0).

### Fourth Embodiment

Next, a fourth embodiment of the present invention will be described. The present embodiment is a modification of the link mechanism in the variable compression ratio mechanism, and is different from the first to third embodiments in terms of, for example, such a configuration that the two first coupling pin 8 and second coupling pin 11 are provided at the control link 14 coupled with the eccentric cam portion 13 of the control shaft 12.

More specifically, this link mechanism 5 includes the upper link 7, the control link 14, and the lower link 10. The upper link 7 is coupled with the piston 2 via the piston pin 3. The control link 14 is swingably coupled with the upper link 7 via the first coupling pin 8 and is also swingably coupled with the eccentric cam portion 13 of the control shaft 12. The lower link 10 is swingably coupled with the control link 14 via the second coupling pin 11 and is also rotatably coupled with the crank pin 9 of the crankshaft 4.

Then, the rotation of the crankshaft 4 is transmitted to the second gear wheel 16 (the control shaft 12) via the first gear wheel 15 while being slowed down to a half angular speed, similarly to the first to third embodiments. This second gear wheel 16 and the control shaft 12 are configured to change the relative rotational phase therebetween by a similar piston position change mechanism 6 to the first to third embodiments.

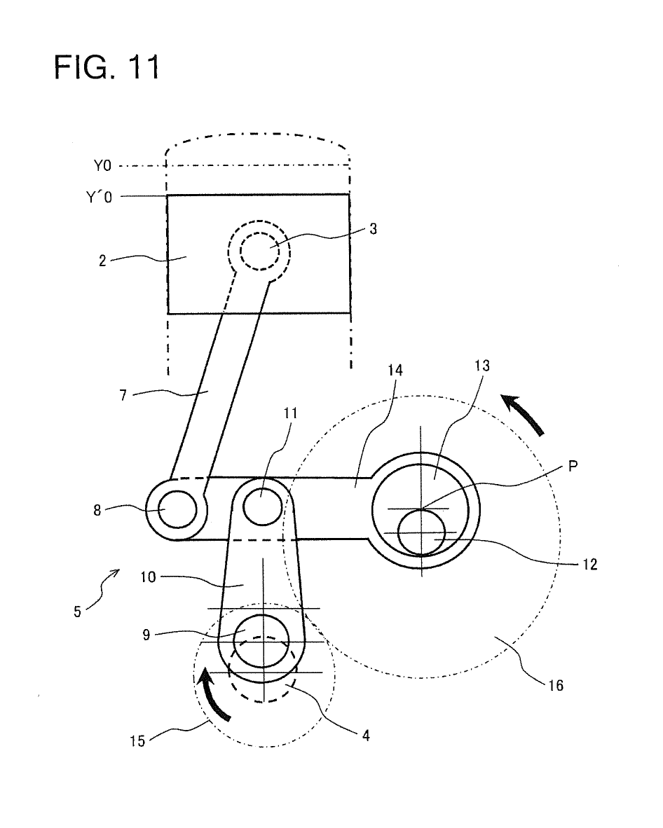

FIG. 11 illustrates a posture around the intake (exhaust) top dead center of the piston 2, i.e., the position where the crank pin 9 faces right above the crankshaft 4. Then, the eccentric rotational direction of the eccentric cam portion 13 is oriented right about the control shaft 12, and the crank pin 9, the second coupling pin 11, and the piston pin 3 face right above each other while being aligned along a generally straight one line.

The eccentric direction of this eccentric cam portion 13 is located right above the control shaft 12, which causes the control link 14 to be pivotally moved in the counterclockwise direction with use of the second coupling pin 11 as a supporting point, and thus the first coupling pin 8 is displaced downward and the upper link 7 pulls down the piston 2. As a result, the position of the piston 2 is located at a relatively low position (Y′0) around the intake (exhaust) top dead center.

When the crankshaft 4 is rotated by 360 degrees in the clockwise direction from this state, the crank pin 9 is located right above the crankshaft 4 again. Further, the eccentric cam portion 13 is rotated by 180 degrees in the counterclockwise direction, and the piston reaches the piston position at the compression top dead center (Y0) around there. In other words, the piston position is lifted to the highest position (Y0) as indicated by an alternate long and short dash line illustrated in FIG. 11. This is because, the eccentric direction of this eccentric cam portion 13 is oriented right below the control shaft 12, which causes the control link 14 to be pivotally moved in the clockwise direction with use of the second coupling 11 as a supporting point. Thus, the first coupling pin 8 is displaced upward, and the upper link 7 pushes up the piston 2.

In this manner, the present embodiment also allows the piston position at the intake (exhaust) top dead center (Y′0) to be set to the lower position than the piston position at the compression top dead center (Y0) similarly to the first to third embodiments, and can effectively prevent the mechanical interference between the intake valve IV and the exhaust valve EV, and the piston from the terminal stage of the exhaust stroke to the initial stage of the intake stroke while securing the high compression ratio or expansion ratio. The present embodiment can also change both the mechanical compression ratio and the mechanical expansion ratio by converting the phase with use of the piston position change mechanism, similarly to the first to third embodiments.

Further, the present embodiment allows the piston position at the intake (exhaust) top dead center (Y′0) to be located at the lower position than the piston position at the compression top dead center (Y0) similarly to the first to third embodiments, and can also improve the internal EGR effect.

The present invention is not limited to the configuration according to each of the above-described embodiments. For example, each of the embodiments has been described based on a single-cylinder internal combustion engine, but the present invention may be applied to a multi-cylinder internal combustion engine, such as a two-cylinder internal combustion engine, a three-cylinder internal combustion engine, and a four-cylinder internal combustion engine. In this case, the piston operation characteristics of all of the cylinders can be changed by a single or a plurality of piston position change mechanism(s), and thus all of the cylinders can be controlled to a desired mechanical compression ratio or mechanical expansion ratio.

Then, each of the embodiments is configured to set the piston position at the intake (exhaust) top dead center to the lower position than the piston position at the compression top dead center by the variable compression ratio mechanism. According thereto, each of the embodiments allows the variable compression ratio mechanism to prevent the crown surface of the piston and the intake/exhaust valve from interfering with each other or sufficiently acquire the internal EGR effect by setting the piston position at the intake (exhaust) top dead center to the low position during the exhaust stroke when the piston position at the compression top dead center is raised to achieve the high mechanical compression ratio.

The embodiments have been described based on the two piston position change mechanism as the transmission mechanism from the piston to the crankshaft, but the configuration of this mechanism may be arbitrarily selected within a range that does not depart from the spirit of the present invention, and is not limited especially. Further, the embodiments have been described based on the example in which the pair of first and second gear wheels 15 and 16 is employed as the speed reduction mechanism that transmits the rotation of the crankshaft 4 to the eccentric cam portion 13 (the control shaft 12) while slowing down the rotation to the half angular speed, but the present invention is not limited thereto.

Further, in each of the embodiments, the rotational direction of the crankshaft 4 and the rotational direction of the eccentric cam portion 13 are oriented in opposite directions from each other, but may be oriented in the same direction. For example, each of the embodiments may be configured to transmit the rotation of the first gear wheel 15 on the crankshaft 4 side to the second gear wheel 16 on the eccentric cam portion 13 side while slowing down this rotation to a half angular speed via a timing belt (a timing chain). In this case, the rotational direction of the crankshaft 4 and the rotational direction of the eccentric cam portion 13 are oriented in the same direction and the characteristic of the change in the piston position (the vertical direction) with respect to the rotational angle of the crankshaft 4 (the horizontal axis) is horizontally inverted, but the spirit of the present invention can be realized.

In the above-described manner, the configuration is not especially limited as long as the configuration falls within the range that does not depart from the spirit of the present invention.

In the above-described manner, according to the present invention, the piston position at the intake (exhaust) top dead center is set to the lower position than the piston position at the compression top dead center by the variable compression ratio mechanism, which brings about the effect of being able to prevent the crown surface of the piston and the intake/exhaust valve from interfering with each other or sufficiently acquiring the internal EGR effect.

There are various technical ideas outside the claims that can be recognized from the above-described embodiments, and representative examples thereof will be described now.

(1) A compression ratio adjustment apparatus for an internal combustion engine includes a variable compression ratio mechanism capable of changing a mechanical compression ratio and a mechanical expansion ratio by changing a stroke position of a piston in a four-cycle internal combustion engine. The variable compression ratio mechanism sets a piston position at an intake (exhaust) top dead center to a generally same position throughout an entire variable range of the variable compression ratio mechanism.

(2) A compression ratio adjustment apparatus for an internal combustion engine includes a variable compression ratio mechanism capable of changing a mechanical compression ratio and a mechanical expansion ratio by changing a stroke position of a piston in a four-cycle internal combustion engine. The variable compression ratio mechanism includes a first link having one end coupled with the piston via a piston pin, a second link rotatably coupled with an opposite end of the first link via a first coupling pin and also rotatably coupled with a crank pin of a crankshaft, a control shaft configured to rotate at an angular speed half the crankshaft, an eccentric axis portion provided on the control shaft and disposed eccentrically with respect to a rotational central axis of the control shaft, a third link having one end coupled with the second link via a second coupling pin and an opposite end rotatably coupled with the eccentric axis portion, and a relative displacement mechanism capable of changing an eccentric direction of the eccentric axis portion with respect to the central axis of the control shaft. A central axis of the eccentric axis portion at a compression top dead center is set so as to be located on an opposite side of the central axis of the control shaft from the second coupling pin, and the central axis of the eccentric axis portion at an expansion top dead center is set so as to be located on one side where the second coupling pin is located with respect to the central axis of the control shaft. At the time of a cold start of the internal combustion engine, the variable compression ratio mechanism sets a piston position at an intake bottom dead center of the piston to an approximately same position as a piston position at an expansion bottom dead center or sets the piston position at the intake bottom dead center to a lower position than the piston position at the expansion bottom dead center.

(3) A compression ratio adjustment apparatus for an internal combustion engine includes a variable compression ratio mechanism capable of changing a mechanical compression ratio and a mechanical expansion ratio by changing a stroke position of a piston in a four-cycle internal combustion engine. The variable compression ratio mechanism includes a first link having one end coupled with the piston via a piston pin, a second link rotatably coupled with an opposite end of the first link via a first coupling pin and also rotatably coupled with a crank pin of a crankshaft, a control shaft configured to rotate at an angular speed half the crankshaft, an eccentric axis portion provided on the control shaft and disposed eccentrically with respect to a rotational central axis of the control shaft, a third link having one end coupled with the second link via a second coupling pin and an opposite end rotatably coupled with the eccentric axis portion, and a relative displacement mechanism capable of changing an eccentric direction of the eccentric axis portion with respect to the central axis of the control shaft. A central axis of the eccentric axis portion at a compression top dead center is set so as to be located on an opposite side of the central axis of the control shaft from the second coupling pin, and the central axis of the eccentric axis portion at an expansion top dead center is set so as to be located on one side where the second coupling pin is located with respect to the central axis of the control shaft. The variable compression ratio mechanism sets a position of a crown surface of the piston at an intake (exhaust) top dead center to a lower side than a maximum lift of an intake valve.

The present invention is not limited to the above-described embodiments, and includes various modifications. For example, the above-described embodiments have been described in detail to facilitate better understanding of the present invention, and are not necessarily limited to the configurations including all of the described features. Further, a part of the configuration of some embodiment can be replaced with the configuration of another embodiment. Further, an addition, a deletion, and a replacement of another configuration can be applied to a part of the configuration of each of the embodiments.

The present invention may be configured in the following manner.

(1) A compression ratio adjustment apparatus for an internal combustion engine includes a variable compression ratio mechanism capable of changing a mechanical compression ratio and a mechanical expansion ratio by changing a stroke position of a piston in a four-cycle internal combustion engine. The variable compression ratio mechanism sets a piston position at an exhaust top dead center to a lower position than a piston position at a compression top dead center of the piston.
(2) In the compression ratio adjustment apparatus for the internal combustion engine described in (1), the variable compression ratio mechanism may set the piston position at the exhaust top dead center to the lower position than the piston position at the compression top dead center of the piston throughout an entire variable range of the variable compression ratio mechanism.
(3) In the compression ratio adjustment apparatus for the internal combustion engine described in (1), the variable compression ratio mechanism may set a piston position at an intake bottom dead center of the piston and a piston position at an expansion bottom dead center to different positions from each other.
(4) In the compression ratio adjustment apparatus for the internal combustion engine described in (3), the variable compression ratio mechanism may individually change the mechanical compression ratio and the mechanical expansion ratio.
(5) In the compression ratio adjustment apparatus for the internal combustion engine described in (3), the variable compression ratio mechanism may control the piston into a state in which an intake stroke and an exhaust stroke match each other or a state in which a compression stroke and an expansion stroke match each other, and set the piston position at the exhaust top dead center to the lower position than the piston position at the compression top dead center in this state.
(6) In the compression ratio adjustment apparatus for the internal combustion engine described in (1), at the time of a cold start of the internal combustion engine, the variable compression ratio mechanism may set a piston position at an intake bottom dead center of the piston to an approximately same position as a piston position at an expansion bottom dead center or set the piston position at the expansion bottom dead center to a higher position than the piston position at the intake bottom dead center.
(7) In the compression ratio adjustment apparatus for the internal combustion engine described in (1), if a driving force is not applied to the variable compression ratio mechanism, the variable compression ratio mechanism may set a piston position at an intake bottom dead center of the piston to an approximately same position as a piston position at an expansion bottom dead center, or to a position that causes the piston position at the expansion bottom dead center to be located at a higher position than the piston position at the intake bottom dead center.
(8) In the compression ratio adjustment apparatus for the internal combustion engine described in (7), if the driving force is not applied to the variable compression ratio mechanism, the variable compression ratio mechanism may set, with use of a biasing member, the piston position at the intake bottom dead center to the approximately same position as the piston position at the expansion bottom dead center or to the position to cause the piston position at the expansion bottom dead center to be located at the higher position than the piston position at the intake bottom dead center.
(9) In the compression ratio adjustment apparatus for the internal combustion engine described in (1), the variable compression ratio mechanism may set the piston position at the exhaust top dead center to a generally same position throughout an entire variable range of the variable compression ratio mechanism.
(10) A compression ratio adjustment apparatus for an internal combustion engine includes a variable compression ratio mechanism capable of changing a mechanical compression ratio and a mechanical expansion ratio by changing a stroke position of a piston in a four-cycle internal combustion engine. The variable compression ratio mechanism includes a first link having one end coupled with the piston via a piston pin, a second link rotatably coupled with an opposite end of the first link via a first coupling pin and also rotatably coupled with a crank pin of a crankshaft, a control shaft configured to rotate at an angular speed half the crankshaft, an eccentric axis portion provided on the control shaft and disposed eccentrically with respect to a rotational central axis of the control shaft, a third link having one end coupled with the second link via a second coupling pin and an opposite end rotatably coupled with the eccentric axis portion, and a relative displacement mechanism capable of changing an eccentric direction of the eccentric axis portion with respect to the central axis of the control shaft. A central axis of the eccentric axis portion at a compression top dead center is set so as to be located on an opposite side of the central axis of the control shaft from the second coupling pin, and the central axis of the eccentric axis portion at an expansion top dead center is also set so as to be located on one side where the second coupling pin is located with respect to the central axis of the control shaft.
(11) In the compression ratio adjustment apparatus for the internal combustion engine described in (10), the variable compression ratio mechanism may be configured in such a manner that the central axis of the eccentric axis portion at the compression top dead center is located on the opposite side of the central axis of the control shaft from the second pin, and the central axis of the eccentric axis portion at the exhaust top dead center is also set on the one side where the second pin is located with respect to the central axis of the control shaft, throughout an entire variable range of the variable compression ratio mechanism.
(12) In the compression ratio adjustment apparatus for the internal combustion engine described in (10), at the time of a cold start of the internal combustion engine, the variable compression ratio mechanism may set a piston position at an intake bottom dead center of the piston to an approximately same position as a piston position at an expansion bottom dead center or set the piston position at the intake bottom dead center to a lower position than the piston position at the expansion bottom dead center.
(13) In the compression ratio adjustment apparatus for the internal combustion engine described in (10), the variable compression ratio mechanism may set a position of a crown surface of the piston at at least one of an intake top dead center and an exhaust top dead center to a lower side than a maximum lift of an intake valve.

Having described merely several embodiments of the present invention, those skilled in the art will be able to easily appreciate that the embodiments described as the examples can be modified or improved in various manners without substantially departing from the novel teachings and advantages of the present invention. Therefore, such modified or improved embodiments are intended to be also contained in the technical scope of the present invention. The above-described embodiments may also be arbitrarily combined.

The present application claims priority under the Paris Convention to Japanese Patent Application No. 2015-084876 filed on Apr. 17, 2015. The entire disclosure of Japanese Patent Application No. 2015-084876 filed on Apr. 17, 2015 including the specification, the claims, the drawings, and the abstract is incorporated herein by reference in its entirety.

### REFERENCE SIGN LIST

01 internal combustion engine
02 cylinder block
03 bore
1 piston position variable mechanism
2 piston
3 piston pin
4 crankshaft
5 link mechanism
6 phase change mechanism
7 upper link (first link)
8 first coupling pin
9 crank pin
10 lower link (second link)
11 second coupling pin
12 control shaft
13 eccentric cam portion
14 control link (third link)
15 first gear wheel (driving rotational member)
16 second gear wheel (driven rotational member)

1. A compression ratio adjustment apparatus for an internal combustion engine, comprising:
a variable compression ratio mechanism capable of changing a mechanical compression ratio and a mechanical expansion ratio by changing a stroke position of a piston in a four-cycle internal combustion engine,
wherein the variable compression ratio mechanism sets a piston position at an exhaust top dead center to a lower position than a piston position at a compression top dead center of the piston.

2. The compression ratio adjustment apparatus for the internal combustion engine according to claim 1, wherein the variable compression ratio mechanism sets the piston position at the exhaust top dead center to the lower position than the piston position at the compression top dead center of the piston throughout an entire variable range of the variable compression ratio mechanism.

3. The compression ratio adjustment apparatus for the internal combustion engine according to claim 1, wherein the variable compression ratio mechanism sets a piston position at an intake bottom dead center of the piston and a piston position at an expansion bottom dead center to different positions from each other.

4. The compression ratio adjustment apparatus for the internal combustion engine according to claim 3, wherein the variable compression ratio mechanism individually changes the mechanical compression ratio and the mechanical expansion ratio.

5. The compression ratio adjustment apparatus for the internal combustion engine according to claim 3, wherein the variable compression ratio mechanism controls the piston into a state in which an intake stroke and an exhaust stroke match each other or a state in which a compression stroke and an expansion stroke match each other, and sets the piston position at the exhaust top dead center to the lower position than the piston position at the compression top dead center in this state.

6. The compression ratio adjustment apparatus for the internal combustion engine according to claim 1, wherein, at the time of a cold start of the internal combustion engine, the variable compression ratio mechanism sets a piston position at an intake bottom dead center of the piston to an approximately same position as a piston position at an expansion bottom dead center or sets the piston position at the expansion bottom dead center to a higher position than the piston position at the intake bottom dead center.

7. The compression ratio adjustment apparatus for the internal combustion engine according to claim 1, wherein, when a driving force is not applied to the variable compression ratio mechanism, the variable compression ratio mechanism sets a piston position at an intake bottom dead center of the piston to an approximately same position as a piston position at an expansion bottom dead center, or to a position that causes the piston position at the expansion bottom dead center to be located at a higher position than the piston position at the intake bottom dead center.

8. The compression ratio adjustment apparatus for the internal combustion engine according to claim 7, wherein, when the driving force is not applied to the variable compression ratio mechanism, the variable compression ratio mechanism sets, with use of a biasing member, the piston position at the intake bottom dead center to the approximately same position as the piston position at the expansion bottom dead center or to the position to cause the piston position at the expansion bottom dead center to be located at the higher position than the piston position at the intake bottom dead center.

9. The compression ratio adjustment apparatus for the internal combustion engine according to claim 1, wherein the variable compression ratio mechanism sets the piston position at the exhaust top dead center to a generally same position throughout an entire variable range of the variable compression ratio mechanism.

10. A compression ratio adjustment apparatus for an internal combustion engine comprising:
a variable compression ratio mechanism capable of changing a mechanical compression ratio and a mechanical expansion ratio by changing a stroke position of a piston in a four-cycle internal combustion engine,
wherein the variable compression ratio mechanism includes a first link having one end coupled with the piston via a piston pin,
a second link rotatably coupled with an opposite end of the first link via a first coupling pin and also rotatably coupled with a crank pin of a crankshaft,
a control shaft configured to rotate at an angular speed half relative to the crankshaft,
an eccentric axis portion provided on the control shaft and disposed eccentrically with respect to a rotational central axis of the control shaft,
a third link having one end coupled with the second link via a second coupling pin and an opposite end rotatably coupled with the eccentric axis portion, and
a relative displacement mechanism capable of changing an eccentric direction of the eccentric axis portion with respect to the central axis of the control shaft,
wherein a central axis of the eccentric axis portion at a compression top dead center is set so as to be located on an opposite side of the central axis of the control shaft from the second coupling pin, and the central axis of the eccentric axis portion at an expansion top dead center is also set so as to be located on one side where the second coupling pin is located with respect to the central axis of the control shaft.

11. The compression ratio adjustment apparatus for the internal combustion engine according to claim 10, wherein the variable compression ratio mechanism is configured in such a manner that the central axis of the eccentric axis portion at the compression top dead center is located on the opposite side of the central axis of the control shaft from the second pin, and the central axis of the eccentric axis portion at the exhaust top dead center is also set on the one side where the second pin is located with respect to the central axis of the control shaft, throughout an entire variable range of the variable compression ratio mechanism.

12. The compression ratio adjustment apparatus for the internal combustion engine according to claim 10, wherein, at the time of a cold start of the internal combustion engine, the variable compression ratio mechanism sets a piston position at an intake bottom dead center of the piston to an approximately same position as a piston position at an expansion bottom dead center or sets the piston position at the intake bottom dead center to a lower position than the piston position at the expansion bottom dead center.

13. The compression ratio adjustment apparatus for the internal combustion engine according to claim 10, wherein the variable compression ratio mechanism sets a position of a crown surface of the piston at least one of an intake top dead center and an exhaust top dead center to a lower side than a maximum lift of an intake valve.
